(19) United States
(12) Patent Application Publication
(10) Pub. No.: US 2025/0282951 A1
(43) Pub. Date: Sep. 11, 2025

(54) LIGNIN BASED TPU COMPOSITION, METHOD OF PREPARING THEREOF AND USES THEREOF

(71) Applicant: BASF SE, Ludwigshafen am Rhein (DE)

(72) Inventors: Md Arifur Rahman, Wyandotte, MI (US); Jacob Forrest Stoneburner, Wyandotte, MI (US); Brad J. Martin, Dearborn, MI (US)

(73) Assignee: BASF SE, Ludwigshafen am Rhein (DE)

(21) Appl. No.: 18/854,597

(22) PCT Filed: Apr. 10, 2023
(86) PCT No.: PCT/EP2023/059346

§ 371 Date: Oct. 7, 2024

Related U.S. Application Data
(60) Provisional application No. 63/329,546, filed on Apr. 11, 2022.

(30) Foreign Application Priority Data
May 24, 2022 (EP) 22175078.9

(51) Int. Cl. C08L 75/08; C08K 11/00; C08L 75/06

(52) U.S. Cl. CPC C08L 75/08; C08K 11/00; C08L 75/06; C08L 2207/04

(57) ABSTRACT

A thermoplastic polyurethane (TPU) composition prepared from a reaction mixture includes a Part A and a Part B. Part A includes at least one isocyanate reactive component, at least one isocyanate in a range of 15 wt. % to 45 wt. % of Part A; and optionally at least one additive. Part B includes at least one lignin component. The at least one isocyanate reactive component includes at least one polyol in a range of 45 wt. % to 75 wt. % of Part A and at least one chain extender in a range of 1.0 wt. % to 10.0 wt. %.

### FIELD OF INVENTION

The present invention relates to a thermoplastic polyurethane (TPU) composition based on lignin, methods of producing the TPU composition, articles made of the TPU composition and uses thereof.

### BACKGROUND OF THE INVENTION

Naturally renewable polymers such as cellulose and lignin are being increasingly used for the improved performance as well as for the ability to replace non-degradable polymers. The natural fibers or fillers based thermoplastic composites are considered bio-reinforced compounds. Use of the naturally renewable polymers also has the ability to reduce the carbon footprint of the thermoplastic polyurethane (TPU). Moreover, the biomass balance of the traditionally formulated TPU is less and does depend on the fossil fuel-based feed stocks. Usage of the naturally renewable polymers provide additional advantage of improving the biomass balance in the traditional TPU.

Lignin, the most commonly used renewable polymer is readily and abundantly found in wood and in the secondary cell walls of plants and some algae. Lignin based on oxidative coupling of primarily 4-hydroxyphenylpropanoids (coniferyl alcohol, sinapyl alcohol, and coumaryl alcohol). Lignin has antimicrobial, antioxidant, fungicidal and photoinhibition properties. Lignin and its derivatives have been used in making composites and coatings because of its particle size, hydrophobicity, and ability to form stable mixtures. Lignin is widely used as a filler material in thermoplastics and thermosetting polymers and rubbers.

CN113265077A discloses polymer composition with 8 parts of lignin sulfonate, CN110790889A discloses up-to 18 parts of acid-precipitated lignin, hydroxy methylated lignin or acetylated hydroxy methylated lignin in polymer compositions. U.S. Pat. No. 10,414,852B2 discloses polymer composition with modified, chemically treated lignin about 4 to 8 wt. % in examples.

CN111040422A discloses use of long lignin fibres of 8 to 22 parts in polymer composition. CN112126215A discloses use of larger lignin particles as well as hydrogenated lignin in polymer composition in about 10 to 12 parts. CN113754851A discloses 0.4-2.7 parts of broad lignin.

The polymer compositions are not disclosed to have improved physical properties as squeaking noise reduction or reduction of gloss value. The presently known lignin based TPUs are not associated with significant positive effects and rather have negative effects on mechanical properties. The mechanical properties of the lignin based TPU are not encouraging/not good for wider acceptability. Also, lignin based TPUs have not been developed for improving surface properties of TPU. Accordingly, there is a need to develop lignin based TPU with improved surface property.

It was, therefore, an object of the present invention to provide for a lignin based TPU composition that has improved melt-strength, improved tensile strength and strain, increased young's modulus, high deformability and no significant increase in viscosity.

Another object of the present invention is to provide for a lignin based TPU composition that has significantly improved gloss and matt finish characteristics.

### SUMMARY OF THE INVENTION

Surprisingly, it has been found that the object is met by providing a thermoplastic polyurethane composition based on lignin in accordance with this invention. Specifically the thermoplastic polyurethane-lignin composition (hereinafter referred to as TPU composition) produced by a special method as disclosed herein meets the objective of the present invention. The TPU composition and the method to make the TPU composition provides the necessary mechanical strength such that, the TPU composition finds use in the manufacture of several articles.

Accordingly, in one aspect, the presently claimed invention is directed to a thermoplastic polyurethane (TPU) composition prepared from a reaction mixture comprising:
a. Part A including
   i. at least one isocyanate reactive component;
   ii. at least one isocyanate in range of 15 wt. % to 35 wt. % of Part A; and
b. Part B including at least one lignin component;
wherein the at least one isocyanate reactive component includes at least one polyol, at least one chain extender, and optionally at least one additive,
wherein the at least one additive is in range of 0.40 wt. % to 25.00 wt. % of Part A and at least one chain extender in range of 1.0 wt. % to 10.0 wt. % and
wherein the at least one lignin component is in the range of 10.0 wt. % to 60.0 wt. % of the total reaction mixture.

In another aspect, the presently claimed invention is directed to a first method of forming the TPU composition, the first method comprising:
a. mixing the at least one isocyanate reactive component and at least one isocyanate of Part A;
b. adding the at least one lignin component of the Part B to mixed components of the Part A in step a. to form the reaction mixture;
c. optionally heating the reaction mixture.

In another aspect, the presently claimed invention is directed to a second method of forming the TPU composition, the second method comprising:
a. providing the at least one lignin component of Part B and the isocyanate reactive component of Part A, wherein the isocyanate reactive component of Part A includes at least one polyol and at least one chain extender;
b. mixing the at least one lignin of Part B and the isocyanate reactive component of Part A to form a premix;
c. mixing the premix of step b. with the at least one isocyanate of Part A to form the TPU composition.

In another aspect, the presently claimed invention is directed to an article prepared by using the TPU composition or the method of forming TPU composition as mentioned above.

In another aspect, the presently claimed invention is directed to use of the TPU composition in preparing shoe soles, floor coverings, footwears, gloves, jackets, garments, garment linings, hats, aprons, scarfs, coats, appliances, consumer electronics, handwares, and parts thereof.

In another aspect, the presently claimed invention is directed to use of the TPU composition in preparing an outsole (103) of the footwear.

In another aspect, the presently claimed invention is directed to an article comprising
at least one receiving unit (101) configured to receive an appendage of a user;
optionally at least one outsole (103); and
optionally at least one insole (102) configured to support the appendage and disposed
between the at least one receiving unit (101) and the at least one outsole (103),
   wherein the at least one receiving unit (101), the at least one insole (102) and/or the at least one outsole (103) is formed of the TPU composition as described hereinabove.

### DETAILED DESCRIPTION OF THE FIGURES

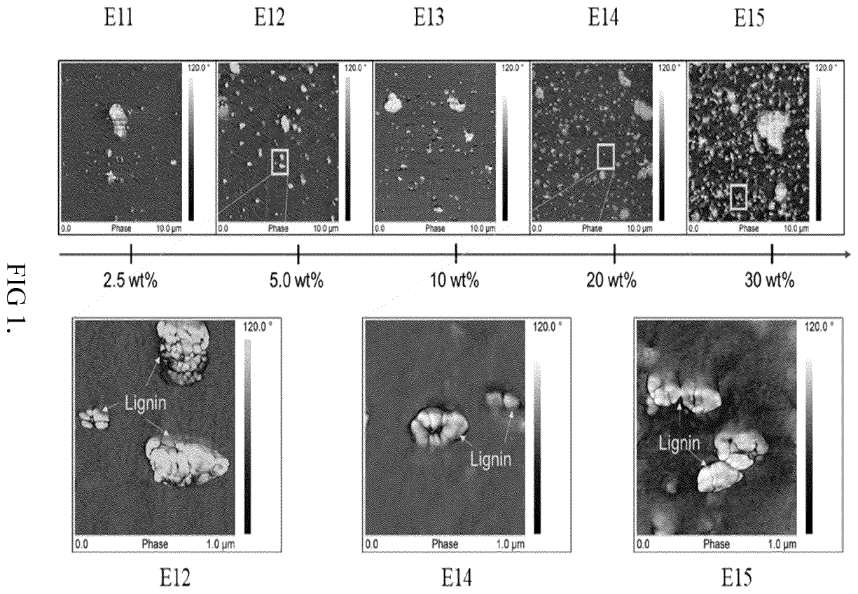

FIG. 1 provides atomic force microscopy (AFM) images of Examples E11 to E15 showing the dispersion of lignin in TPU composition.

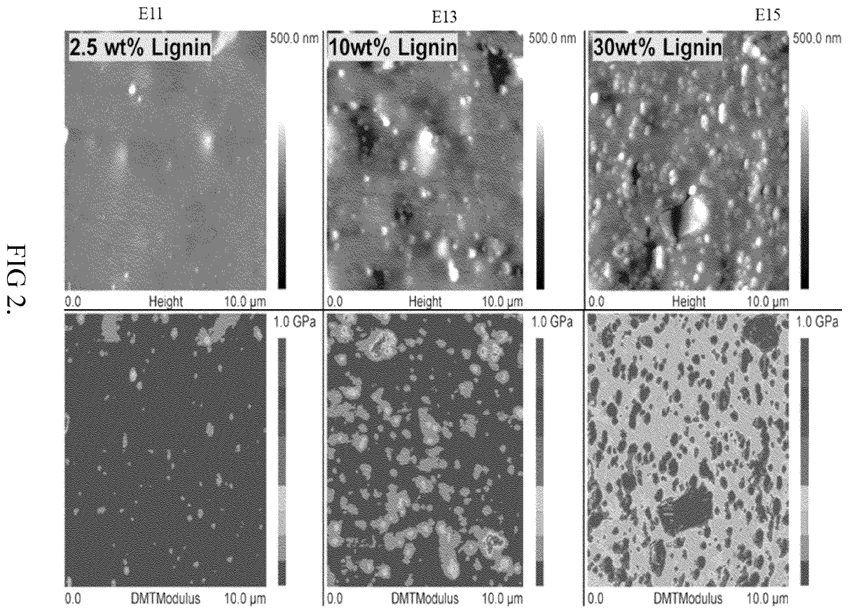

FIG. 2 provides AFM images for Examples E11, E13 and E15 showing high modulus surface of TPU/lignin compounds

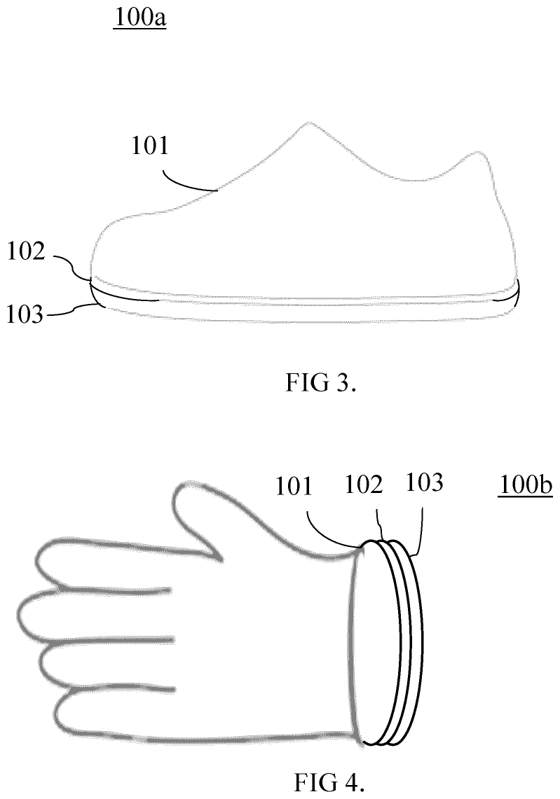

FIG. 3. depicts an article in form of a footwear (100a) having a receiving unit (101), an insole (102) and an outsole (103).

FIG. 4. depicts an article in form of a hand glove (100b) having a receiving unit (101), an insole (102) and an outsole (103).

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps are carried out simultaneously or there are time intervals of seconds, minutes, hours, days, weeks, months or even years between such steps, unless otherwise indicated in the application as set forth herein above or below.

In the following passages, different aspects of the invention are defined in more detail. Each aspect so defined are combined with any other aspect or aspects unless clearly indicated to the contrary. In particular, any feature indicated as being preferred or advantageous are combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the features, structures or characteristics are combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments are used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to applicable law.

An aspect of the present invention is directed towards a thermoplastic polyurethane (TPU) composition prepared from a reaction mixture comprising:
a. Part A including
   i. at least one isocyanate reactive component;
   ii. at least one isocyanate in range of 15 wt. % to 45 wt. % of Part A; and
   iii. optionally at least one additive; and
b. Part B including at least one lignin component;
wherein the at least one isocyanate reactive component includes at least one polyol in range of 0.40 wt. % to 25.00 wt. % of Part A and at least one chain extender in range of 1.0 wt. % to 10.0 wt. % and
wherein the at least one lignin component is in the range of 10.0 wt. % to 60.0 wt. % of the total reaction mixture.

### Part A

Part A of the TPU composition includes at least one isocyanate reactive component and at least one isocyanate.

### Isocyanate Reactive Component

In an embodiment, the isocyanate reactive component (IRC) of the TPU composition comprises at least one polyol, at least one chain extender, and optionally an additive. The optional additive includes an antioxidant, a mold release agent, a lubricant, a plasticiser, a hydrolysis stabilizer, an anti-blocking agent, a light stabilizer, a cross linker, a catalyst, a flame retardant, a rheology additive, a defoamer, a friction reducer, an antistatic agent, a surfactant, and other components, or combination thereof.

### Polyol

In an embodiment, the TPU composition has at least one polyol including polyether polyols, polyester polyols, polyetherester polyols, and a combination thereof.

In an embodiment, the polyether polyols are obtainable by known methods, for example by anionic polymerization with alkali metal hydroxides, e.g., sodium hydroxide or potassium hydroxide, or alkali metal alkoxides, e.g., sodium methoxide, sodium ethoxide, potassium ethoxide or potassium isopropoxide, as catalysts and by adding at least one amine-containing starter molecule, or by cationic polymerization with Lewis acids, such as antimony pentachloride, boron fluoride etherate and so on, or fuller's earth, as catalysts from one or more alkylene oxides having 2 to 4 carbon atoms in the alkylene moiety.

Starter molecules are generally selected such that their average functionality is in the range of 2.0 to 8.0, or in the range of 3.0 to 8.0. Optionally, a mixture of suitable starter molecules is used.

Starter molecules for polyether polyols include amine containing and hydroxyl-containing starter molecules. Suitable amine containing starter molecules include, for example, aliphatic and aromatic diamines such as ethylenediamine, propylenediamine, butylenediamine, hexamethylenediamine, phenylenediamines, toluenediamine, diaminodiphenylmethane and isomers thereof.

Other suitable starter molecules further include alkanolamines, e.g. ethanolamine, N-methylethanolamine and N-ethylethanolamine, dialkanolamines, e.g., diethanolamine, N-methyldiethanolamine and N-ethyldiethanolamine, and trialkanolamines, e.g., triethanolamine, and ammonia.

Suitable amine containing starter molecules are selected from ethylenediamine, phenylenediamines, toluenediamine or isomers thereof. In one embodiment, it is ethylenediamine.

Hydroxyl-containing starter molecules are selected from sugars, sugar alcohols, for e.g. glucose, mannitol, sucrose, pentaerythritol, sorbitol; polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water or a combination thereof.

Suitable hydroxyl containing starter molecules are selected from sugar and sugar alcohols such as sucrose, sorbitol, glycerol, pentaerythritol, trimethylolpropane or mixtures thereof. In some embodiments the hydroxyl containing starter molecules are selected from sucrose, glycerol, pentaerythritol or trimethylolpropane.

Suitable alkylene oxides having 2 to 4 carbon atoms are, for example, ethylene oxide, propylene oxide, tetrahydrofuran, 1,2-butylene oxide, 2,3-butylene oxide, and styrene oxide. Alkylene oxides are used singly, alternatingly in succession or as mixtures. In one embodiment, the alkylene oxides are propylene oxide and/or ethylene oxide. In some embodiments, the alkylene oxides are mixtures of ethylene oxide and propylene oxide that comprise more than 50 wt.-% of propylene oxide.

In another preferred embodiment, the polyester polyols are based on the reaction product of carboxylic acids or anhydrides with hydroxy group containing compounds. Suitable carboxylic acids or anhydrides have from 2 to 20 carbon atoms, or from 4 to 18 carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, oleic acid, phthalic anhydride. Particularly comprising of phthalic acid, isophthalic acid, terephthalic acid, oleic acid and phthalic anhydride or a combination thereof.

Suitable hydroxyl containing compounds are selected from ethanol, ethylene glycol, propylene-1,2-glycol, propylene-1,3-glycol, butyl-ene-1,4-glycol, bu-tylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane, hexane-1,2,6-triol, butane-1,2,4-triol, trimethylolethane, pentaerythritol, quinitol, mannitol, sorbitol, methyl glycoside, diethylene glycol, triethylene glycol, tetraethylene glycol, polyethylene glycol, dipropylene glycol, polypropylene glycol, polyethylenepropylene glycol, dibutylene glycol or polybutylene glycol. In one embodiment, the hydroxyl containing compound is selected from ethylene glycol, propylene-1,2-glycol, propylene-1,3-glycol, butylene-1,4-glycol, butylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane, hexane-1,2,6-triol, butane-1,2,4-triol, trimethylolethane, pentaerythritol, quinitol, mannitol, sorbitol, methyl glycoside or diethylene glycol. In another embodiment, the hydroxyl containing compound is selected from ethylene glycol, propylene-1,2-glycol, propylene-1,3-glycol, butylene-1,4-glycol, butylene-2,3-glycol, hexane-1,6-diol, octane-1,8-diol, neopentyl glycol or diethylene glycol. In still another embodiment, the hydroxyl containing compound is selected from hexane-1,6-diol, neopentyl glycol and diethylene glycol.

Such polyetherester polyols are obtainable as a reaction product of i) at least one hydroxyl-containing starter molecule; ii) of one or more fatty acids, fatty acid monoesters or mixtures thereof; iii) of one or more alkylene oxides having 2 to 4 carbon atoms.

The starter molecules of component i) are generally selected such that the average functionality of component i) is in range from 3.8 to 4.8, or from 4.0 to 4.7, or even from 4.2 to 4.6. Optionally, a mixture of suitable starter molecules is used.

Suitable hydroxyl containing starter molecules of component i) are selected from sugars, sugar alcohols (glucose, mannitol, sucrose, pentaerythritol, sorbitol), polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water or a combination thereof.

In another preferred embodiment, the hydroxyl containing starter molecules of component i) are selected from sugars and sugar alcohols such as sucrose and sorbitol, glycerol, and mixtures of said sugars and/or sugar alcohols with glycerol, water and/or glycols such as, for example, diethylene glycol, dipropylene glycol or combination thereof.

Said fatty acid or fatty acid monoester ii) is selected from polyhydroxy fatty acids, ricinoleic acid, hydroxyl-modified oils, hydroxyl-modified fatty acids and fatty acid esters based in myristoleic acid, palmitoleic acid, oleic acid, stearic acid, palmitic acid, vaccenic acid, petroselic acid, gadoleic acid, erucic acid, nervonic acid, linoleic acid, a- and g-linolenic acid, stearidonic acid, arachidonic acid, timnodonic acid, clupanodonic acid and cervonic acid or a combination thereof. Fatty acids are used as purely fatty acids. In this regard, preference is given to using fatty acid methyl esters such as, for example, biodiesel or methyl oleate.

Biodiesel is to be understood as meaning fatty acid methyl esters within the meaning of the EN 14214 standard from 2010. Principal constituents of biodiesel, which is generally produced from rapeseed oil, soybean oil or palm oil, are methyl esters of saturated C16 to C18 fatty acids and methyl esters of mono- or polyunsaturated C18 fatty acids such as oleic acid, linoleic acid and linolenic acid.

Suitable alkylene oxides iii) having 2 to 4 carbon atoms are, for example, ethylene oxide, propylene oxide, tetrahydrofuran, 1,2-butylene oxide, 2,3-butylene oxide and/or styrene oxide. Alkylene oxides are used singly, alternatingly in succession or as mixtures.

In another preferred embodiment, the alkylene oxides comprise propylene oxide and ethylene oxide. In another preferred embodiment, the alkylene oxide is a mixture of ethylene oxide and propylene oxide comprising more than 50 wt.-% of propylene oxide. In another embodiment, the alkylene oxide comprises purely propylene oxide.

In another preferred embodiment, the polyol is in amount in range from 40 wt. % to 80 wt. % of the Part A. In a more preferred embodiment, the polyol is in amount in range from 40 wt. % to 75 wt. %, or from 45 wt. % to 72 wt. %.

In another preferred embodiment, the at least one polyol has an average functionality in the range of 2.0 to 8.0, the hydroxyl number in the range of 20 mg KOH/g to 800 mg KOH/g and the nominal molecular weight in the range of 200 g/mole to 6000 g/mole.

In another preferred embodiment, the polyol has OH value ranging from 20 mg KOH/g to 800 mg KOH/g, or from 20 mg KOH/g to 750 mg KOH/g, or from 20 mg KOH/g to 700 mg KOH/g, or from 20 mg KOH/g to 650 mg KOH/g, or from 20 mg KOH/g to 600 mg KOH/g. In another preferred embodiment, the polyol has OH value ranging from 25 mg KOH/g to 600 mg KOH/g, or from 30 mg KOH/g to 600 mg KOH/g, or from 40 mg KOH/g to 600 mg KOH/g, 50 mg KOH/g to 600 mg KOH/g. In the present context, OH value is determined according to DIN 53240-1.

In another preferred embodiment, the polyol used are with the molecular weight distribution in range from 100 g/mol to 6000 g/mol, or from 200 g/mol to 6000 g/mol, or from 300 g/mol to 6000 g/mol, or from 350 g/mol to 6000 g/mol. In yet another embodiment, the polyol used are with the molecular weight distribution in range from 350 g/mol to 4500 g/mol, or from 350 g/mol to 4000 g/mol, or from 350 g/mol to 3500 g/mol, or from 350 g/mol to 3000 g/mol, or from 350 g/mol to 3000 g/mol.

In a preferred embodiment, the at least one polyol is selected from polyether polyols, polyester polyols, polyetherester polyols, polytetrahydrofuran, polycarbonate polyols, or a combination thereof.

In another preferred embodiment, the at least one polyol is a polyol mixture based on the mixture of at least two polyols, or at least three polyols, preferably separately prepared polyol. By the expression “at least two polyols” it is meant that two different polyols are used, which have different mean molecular weight data. By the expression “at least three polyols” it is meant that three different polyols are used, which have different mean molecular weight data.

In another preferred embodiment, the polyol mixture includes two different polyols with the molecular weight ratio in range of 1:10 to 10:1, or in range of 1:9 to 9:1 or in the range of 1:8 to 8:1 or in range of 1:7 to 7:1 or in the range of 1:6 to 6:1, or in the range 1:5 to 5:1 or in the range 1:4 to 4:1 or in the range of 1:3 to 3:1 or in the range of 1:2 to 2:1. More preferred the polyol composition includes two polyols with molecular weight ratio of 1:1.

In another preferred embodiment, the at least one polyol is a polyol mixture based on the mixture of at least three, preferably separately prepared polyol. Separately prepared polyol includes polyether polyols, polyester polyols, polyetherester polyols, and a combination thereof. As described hereinabove, separately prepared polyols are polyols differentiated based on the difference of the starter molecules used in preparation thereof. By the expression “at least three polyol” it is meant that three different polyols are used, which have different mean molecular weight data.

In another preferred embodiment, the polyols in the polyol mixture are selected from Polytetrahydrofurane (PolyTHF), polyether polyols, polyester polyols, or polycarbonate polyols. In one embodiment, the polyol comprises a PolyTHF.

PolyTHF is well known and available in various molecular weights commercially.

In another preferred embodiment, PolyTHF used are with the molecular weight distribution in range from 500 g/mol to 2500 g/mol, or from 550 g/mol to 2500 g/mol, or from 600 g/mol to 2500 g/mol, or from 625 g/mol to 2500 g/mol. In yet another embodiment, the PolyTHF used are with the molecular weight distribution in range from 625 g/mol to 2450 g/mol, or from 625 g/mol to 2400 g/mol, or from 625 g/mol to 2350 g/mol, or from 625 g/mol to 2300 g/mol, or from 625 g/mol to 2250 g/mol, or from 625 g/mol to 2200 g/mol, or from 625 g/mol to 2150 g/mol, or from 625 g/mol to 2100 g/mol, or from 625 g/mol to 2050 g/mol. A more preferred Poly THF is with molecular weight in range from 625 g/mol to 2050 g/mol.

In another preferred embodiment, the polyol mixture is a PolyTHF mixture (i) based on the mixture of at least two, preferably separately prepared PolyTHF. By the expression “at least two PolyTHF” it is meant that two different PolyTHF are used, which have different mean molecular weight data. In another preferred embodiment, the polyol composition includes the PolyTHF of molecular weight range of 975 g/mol to 1025 g/mol and the PolyTHF of molecular weight range of 1950 g/mol to 2050 g/mol in weight ratio of 1:1.

In another preferred embodiment, the polyol mixture includes at least two different polyester polyols.

In another preferred embodiment, the polyol mixture includes at least two PolyTHF and at least one polyester polyol.

In another preferred embodiment, the polyol mixture includes three polyols with the molecular weight ratio in range of 8:8:1 to 1:1:1 or in range of 7.5:7.5:1 to 1:1:1.

### Chain Extender

In an embodiment, suitable chain extenders and/or cross linkers are present in the isocyanate reactive component in Part A of TPU composition. The addition of bifunctional chain extenders, trifunctional and higher-functional cross linkers or, if appropriate, mixtures thereof might be added.

In an embodiment, the chain extender has a molecular weight of less than 499 g/mol. In the context of the present invention, the chain extender is understood to mean a compound having at least two functional groups reactive toward isocyanates, for example hydroxyl groups, amino groups or thiol groups, and a molecular weight Mw of less than 499 g/mol. At the same time, in the context of the present invention, the polyol composition is also free of compounds of this kind.

In another embodiment, the chain extenders and/or cross linkers used are alkanol amines and in particular diols and/or triols having molecular weights in between 60 g/mol to 300 g/mol. Suitable amounts of these chain extenders and/or cross linkers are added and are known to the person skilled in the art.

In a preferred embodiment, the chain extender is in range of 0.0 to 10 wt. % of the Part A. In a more preferred embodiment, the chain extender is in range of 0.1 to 10 wt. % or in range of 1.0 to 10 wt. % or in range of 2.0 to 10.0 wt. % of the Part A. In a more preferred embodiment, the chain extender is in range of 2.0 to 9.5 wt. % or in range of 2.0 to 9.0 wt. % of the Part A.

In another preferred embodiment, the chain extenders have a molecular weight less than 300 g/mol, or in range from 10 g/mol to 210 g/mol. Another preferred chain extender has a molecular weight in range from 50 g/mol to 150 g/mol, or from 50 g/mol to 120 g/mol, or from 60 g/mol to 120 g/mol.

Suitable chain extenders are be selected from mono-ethylene glycol, ethylene glycol, 1,2-propanediol, 1,3-propanediol, 1-5 pentanediol, 1,6-hexanediol, 1,10-decanediol, 1,2-dihydroxycyclohexane, 1,3-dihydroxycyclohexane, 1,4-dihydroxycyclohexane, diethylene glycol, 1,4-butanediol, bis(2-hydroxy-ethyl) hydroquinone, dipropylene glycol, glycerol, diethanolamine, and triethanolamine. In a preferred embodiment, the chain extender is selected from 1,2-ethylene glycol, 1,3-propylene glycol, 1,4 butane diol, 1,5-pentane diol, 1,6-hexane diol, Hydroquinone Bis (2-hydroxyethyl) Ether (HQEE), or/and hydroxyethylether of resorcinol or 1,3-Bis (2-hydroxyethyl) resorcinol (HER).

In one embodiment, suitable chain extenders and/or cross linkers present in the polyurethane resin composition is further described. The addition of bifunctional chain extenders, trifunctional and higher-functional cross linkers or, if appropriate, mixtures thereof might be added. Chain extenders and/or cross linkers include alkanol amines and in particular diols and/or triols. In an embodiment, chain extenders have molecular weights in range from 60 g/mol to 300 g/mol. Suitable amounts of these chain extenders and/or cross linkers are added and are known to the person skilled in the art.

In the context of the present invention, the amount of the chain extender and the polyol composition may vary within wide ranges. In another embodiment, the weight ratio between the chain extender and the polyol composition is in the range of 0.015:1.0 to 0.15:1.0. In another embodiment, the weight ratio between the chain extender and the polyol composition is in the range from 0.015:1.0 to 0.14:1.0, or from 0.015:1.0 to 0.13:1.0, or from 0.015:1.0 to 0.12:1.0. In still another embodiment, the weight ratio between the chain extender and the polyol composition is in the range from 0.015:1.0 to 0.11:1.0, or from 0.016:1.0 to 0.11:1.0, or from 0.017:1.0 to 0.11:1.0.

For the preparation of the TPU, a suitable isocyanate index is required to be maintained. The index is defined here as the ratio of the total for number of isocyanate groups of the isocyanate composition used in the reaction to the isocyanate-reactive groups, i.e., the groups of polyol composition and the chain extender. At an index of 100, there is one active hydrogen atom per isocyanate group of the isocyanate composition. At indices exceeding 100, there are more isocyanate groups than isocyanate-reactive groups. In an embodiment, the index for preparing the TPU is in the range from 90 to 110. In a preferred embodiment, the isocyanate index value is 100.

### Additives:

In an embodiment, the TPU is formed as a reaction product of the Part A and Part B. The isocyanate reactive component of Part A includes at least one additive.

In an embodiment, the additives include catalysts, diols, antioxidants, mold release agents, lubricants, plasticizers, hydrolysis stabilizers, antiblocking agents, light stabilizers, UV Light absorber, surface-active substances, flame retardants, nucleating agents, oxidation stabilizers, dyes, pigments, dyes, hindered amine, ultra violet stabilizers, hydroxy stabilizers, epoxy plasticizers, chain regulator, polyethylene wax, defoamers, internal release agents, desiccants, blowing agents and anti-static agents or combinations thereof. Further details regarding additives are found, for example, in the Kunststoffhandbuch, Volume 7, “Polyurethane” Carl-Hanser-Verlag Munich, 1st edition, 1966 2nd edition, 1983 and 3rd edition, 1993.

### Catalysts:

In an embodiment, the TPU composition includes catalyst. Catalysts are well known to the person skilled in the art. Catalysts include tertiary amine, phosphine compounds, metal catalysts such as chelates of various metals, acidic metal salts of strong acids; strong bases, alcoholates and phenolates of various metals, salts of organic acids with a variety of metals, organometallic derivatives of tetravalent tin, trivalent and pentavalent As, Sb and Bi and metal carbonyls of iron and cobalt and mixtures thereof are used as catalysts.

Catalysts in form of tertiary amines include triethylamine, tributylamine, N-methylmorpholine, N-ethylmorpholine, N,N,N′, N′-tetramethylethylenediamine, pentamethyl-diethylenetriamine and higher homologues (as described in, for example, DE-A 2,624,527 and 2,624,528), 1,4-diazabicyclo(2.2.2) octane, N-methyl-N′-dimethyl-aminoethylpiperazine, bis-(dimethylaminoalkyl) piperazines, tris(dimethylaminopropyl) hexahydro-1,3,5-triazin, N,N-dimethylbenzylamine, N,N-dimethylcyclohexylamine, N,N-diethyl-benzylamine, bis-(N,N-diethylaminoethyl) adipate, N,N,N′, N′-tetramethyl-1,3-butanediamine, N,N-dimethyl-p-phenylethylamine, 1,2-dimethylimidazole, 2-methylimidazole, monocyclic and bicyclic amines together with bis-(dialkylamino)alkyl ethers, such as 2,2-bis-(dimethylaminoethyl) ether, as well as triazine compounds, including tris(dimethylaminopropyl) hexahydro-1,3,5-triazin.

Catalysts as organic metal compounds are selected from the group consisting of tin organyls, titanium organyls, zirconium organyls, hafnium organyls, bismuth organyls, zinc organyls, aluminum organyls and iron organyls, for example tin organyl compounds, tin dialkyls such as dimethyltin or diethyltin, or tin organyl compounds of aliphatic carboxylic acids, tin diacetate, tin dilaurate, dibutyltin diacetate, dibutyltin dilaurate, bismuth compounds such as bismuth alkyl compounds or the like, or iron compounds, iron (MI) acetylacetonate, or the metal salts of the carboxylic acids, for example tin (II) isooctoate, tin dioctoate, titanic esters or bismuth (III) neodecanoate.

In an embodiment, the catalysts, as described hereinabove, are present in amounts up to 20 wt.-% based on the total weight of the TPU composition.

### Stabilizers

In an embodiment, the TPU composition includes a stabilizer. Hydrolysis stabilizers used include oligomeric and/or polymeric aliphatic or aromatic carbodiimides.

In order to stabilize the PU composition, with respect to aging, it is preferable that stabilizers are added to the PU composition. For the purposes of the present invention, stabilizers are additives which protect a plastic or a plastics mixture from damaging environmental effects. Examples are primary and secondary antioxidants, hindered amine light stabilizer, UV absorber, hydrolysis stabilizer, quencher, and flame retardant. Examples of commercial stabilizers are given in Plastics Additive Handbook, 5th Edition, H. Zweifel, ed., Hanser Publishers, Munich, 2001 ([1]), pp. 98-136. In an embodiment, the hydrolysis stabilizer includes Benzene, 1,3-bis(1-isocyanato-1-methylethyl)-, homopolymer, polyethylene glycol mono-Me-ether-blocked.

### Antioxidants

In an embodiment, the TPU composition includes at least one antioxidant. The antioxidant facilitates exposure of the TPU to thermoxidative degradation. In a preferred embodiment, the antioxidant is a phenolic antioxidant. The phenolic antioxidants are described in Plastics Additive Handbook, 5th edition, H. Zweifel, ed, Hanser Publishers, Munich, 2001, pp. 98-107 and pp. 116-121. In a preferred embodiment, the phenolic antioxidants with molar mass is greater than 700 g/mol. The phenolic antioxidant include pentaerythrityl tetrakis(3-(3,5-bis(1,1-dimethylethyl)-4-hydroxyphenyl) propionate) (Irganox® 1010), N,N′-(hexane-1,6-diyl)bis[3-(3,5-di-tert-butyl-4-hydroxyphenyl) propenamide] or blends thereof. In an embodiment, the concentrations generally used of the phenolic antioxidants are in range from 0.1 to 5% by weight, or from 0.1 to 2% by weight, or from 0.5 to 1.5% by weight, based in each case on the total weight of the TPU.

### UV Absorber

The PU composition optionally includes a UV absorber. UV absorbers are molecules which absorb high-energy UV light and dissipate the energy. Familiar UV absorbers used industrially are, for example, members of the group of cinnamic esters, of diphenylcyanoacrylates, of the formamidines, of the benzylidenemalonates, of the diarylbutadienes, or triazines, or of the benzotriazoles. Examples of commercial UV absorbers are found in Plastics Additive Handbook, 5th edition, H. Zweifel, ed, Hanser Publishers, Munich, 2001, pp. 116-122. In one preferred embodiment, the number-average molar mass of the UV absorbers is greater than 300 g/mol, in particular greater than 390 g/mol. The UV absorbers have molar mass no greater than 5000 g/mol, or no greater than 2000 g/mol. The benzotriazoles group is particularly suitable as UV absorber. Examples of benzotriazoles are Tinuvin® 213, Tinuvin® 328, Tinuvin® 571, and also Tinuvin® 384, and Eversorb®82. The amounts added of the UV absorbers are in range from 0.01 to 5% by weight, based on the total weight of antistatic, polyurethane, or in range from 0.1 to 2.0% by weight, or in range from 0.2 to 0.5% by weight, based in each case on the total weight of the antistatic polyurethane.

In a preferred embodiment, the UV absorbers have a number average molecular weight of greater than 0.3×10³ g/mol, or greater than 0.39×10³ g/mol. Furthermore, the UV absorbers have a molecular weight of not greater than 5×10³ g/mol, or not greater than 2×10³ g/mol.

Particularly suitable UV absorbers are from the group of benzotriazoles. Examples of benzotriazoles are Tinuvin® 213, Tinuvin® 234, Tinuvin® 571 and Tinuvin® 384, Eversorb®82, Tinuvin 312 (i.e. Oxanilide UV absorber, Ethane diamide, N-(2-ethoxyphenyl)-N′-(2-ethylphenyl), and Tinuvin 328 (i.e. CAS No. 25973-55-1, Chemical formula: 2-(2H-benzotriazol-2-yl)-4, 6-ditertpentylphenol). The UV absorbers are usually added in amounts of in range from 0.01 to 5% by weight, based on the total mass of the PU, or in range of 0.1-2.0% by weight, or in range of 0.2-0.5% by weight.

### HALS

A UV stabilization as described above based on an antioxidant and a UV absorber is often still not sufficient to ensure good stability of the film against the damaging influence of UV rays. In this case, a hindered amine light stabilizer (HALS) are added in addition to the antioxidant and the UV absorber to the film. HALSs are highly efficient UV stabilizers for most polymers.

HALS compounds are generally known and commercially available. Examples of commercially available HALSs are found in Plastics Additive Handbook, 5th edition, H. Zweifel, Hanser Publishers, Munich, 2001, pp. 123-136.

As hindered amine light stabilizers, preference is given to employing hindered amine light stabilizers in which the number average molecular weight is greater than 500 g/mol. Furthermore, the molecular weight of the preferred HALS compounds should be not greater than 10 000 g/mol, or not greater than 5000 g/mol.

In a preferred embodiment, hindered amine light stabilizers are bis(1,2,2,6,6-pentamethylpiperidyl) se-bacate (Tinuvin® 765, Ciba Spezialitatenchemie AG) and the condensation product of 1-hydrox-yethyl-2,2,6,6-tetramethyl-4-hydroxypiperidine and succinic acid (Tinuvin® 622). Particular preference is given to the condensation product of 1-hydroxyethyl-2,2,6,6-tetramethyl-4-hydroxypiperidine and succinic acid (Tinuvin® 622) when the titanium content of the product is <150 ppm, or <50 ppm, or <10 ppm. HALS compounds are in a concentration of in range from 0.01 to 5% by weight, or from 0.1 to 1% by weight, or from 0.15 to 0.3% by weight referring to the total weight of the film.

In a preferred embodiment of the film, hydrolysis inhibitors are comprised in the PU composition as auxiliaries; preference is given here to oligomeric and/or polymeric aliphatic or aromatic carbodiimides.

Further details regarding the abovementioned auxiliaries and additives are found in the specialist literature, for example in Plastics Additive Handbook, 5th edition, H. Zweifel, ed., Hanser Publishers, Munich, 2001.

### Mold Release Agents:

In an embodiment, the TPU composition includes a mold release agent. The mold release agent include release agents based on wax or silicon, mold release agents based on salts of aliphatic mono- or polycarboxylic acids having at least 25 carbon atoms, and primary mono-, di-, or polyamines having two or more carbon atoms, or amide or ester group-containing amines, which have at least one primary, secondary or tertiary amino group, release agents based on mixtures of at least two compounds from the group of amine-carboxylic acid-salts, saturated or unsaturated CeOH- and/or OH group-containing esters from mono- and/or poly carboxylic acids, and multivalent alcohols or natural and/or synthetic oils, fats or waxes, mold release agents based on ketimines, aldimines, enamines or cyclic Schiff bases. In an embodiment, the mold release agent used is Ethylene-bis-stearamide.

### Friction Reducers:

In an embodiment, the TPU composition includes friction reducers. The friction reducers include polyethylene and polytetrafluoroethylene (PTFE) powders. Polyethylene includes non-crosslinked polyethylene. In an embodiment, the non-cross-linked polyethylene includes high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low-density polyethylene (LLDPE), (VLDPE) and (ULDPE)

### Fillers:

In an embodiment, the reaction mixture for the TPU composition includes fillers. Fillers include silicatic minerals, phyllosilicates, metal oxides, metal salts, calk, heavy spar, pigments, glass, and other fillers. Silicatic minerals include finely ground quartzes. Phyllosilicates includes antigorite, serpentine, hornblendes, amphibols, chrysotile, and talc. Metal oxides include kaolin, aluminum oxides, aluminium hydroxides, magnesium hydroxides, hydromagnesite, titanium oxides and iron oxides. Inorganic pigments include cadmium sulfide, zinc sulfide, and also glass and others. In another embodiment, the filler includes kaolin (china clay), finely ground quartzes, aluminum silicate, and coprecipitates of barium sulfate and aluminum silicate.

Suitable fillers have an average particle diameter in the range of 0.1 μm to 500 μm, or in the range of 1 μm to 100 μm, or in the range of 1 μm to 10 μm. Diameter in this context, in the case of non-spherical particles, refers to their extent along the shortest axis in space.

Suitable amounts of the fillers are present in the polyurethane resin composition which are known to the person skilled in the art. For instance, fillers are present in an amount up to 50 wt.-%, based on the total weight of the polyurethane resin composition.

### Flame Retardants:

In an embodiment, the TPU composition includes flame retardants. Flame retardants include tetrabromobisphenol A, brominated polystyrene oligomers, brominated butadiene-polystyrene copolymers in accordance with WO 2007/058736, tetrabromobisphenol A diallyl ether, and hexabromocyclododecane (HBCD), in particular the industrial products, where these in essence comprise the α-, β-, and γ-isomer with added synergists, such as dicumyl. Preference is given to brominated aromatics, such as tetrabromobisphenol A, and to brominated styrene oligomers. Examples of suitable halogen-free flame retardants are expandable graphite, red phosphorus, and phosphorus compounds, such as triphenyl phosphate and 9,10-dihydro-9-oxa-10-phosphaphenanthrene 10-oxide.

In a preferred embodiment, the flame retardant is graphite. The graphite includes graphite ore treated with sulfuric acid by intercalation process. The graphite ore has bulk density in range of 0.45 to 0.60 g/cm³.

Preferred phosphorus compounds are tris(2-chloroisopropyl) phosphate, triethyl phosphate, diethyl ethylphosphonate, cresyl diphenyl phosphate, Exolit OP560, diphenyl 6-(diphenoxyphosphoryloxy) hexahydrofuro[3,2-b]furan-3-yl phosphate, 9,10-dihydro-9-oxa-10-phosphaphenanthrene 10-oxide, and 6H-dibenzo[c,e][1,2]oxaphosphorine 6-oxide.

Preference is moreover given to organic peroxides (dicumyl peroxide), sulfur, and disulfides as synergists. The abovementioned flame retardants are either dissolved in the monomers before the polymerization reaction starts or incorporated in the PU by extrusion.

In another preferred embodiment, the flame retardant is selected from triaryl phosphate isoproxyliert as well as a halogen free, flame-retardant additive, comprising salt of melamine and cyanuric acid.

### Antistatic Agents:

In an embodiment, the TPU composition includes antistatic additives and antistatic polymers. DE 3531660 describes antistatic polyurethane shoe soles. The antistatic effect is achieved via in range from 0.01 to 0.3% by weight of chemically bonded sulfonate groups. The volume resistivities achieved are <10⁸ Ω/cm. The use of various quaternary ammonium salts for increasing the conductivity of polymers is described in EP 1134268. This involves modifications of commercially available antistatic agents, such as Catafor F® or Catafor PU® from Rhodia. For example, volume resistivities of about 107 Ω/cm are achieved at high concentrations.

Antistatic additives include ethylmethylimidazole ethyl sulfate. Ethylmethylimidazole ethyl sulfate are used here alone or in a mixture, for example together with other antistatic additives. It is preferable that ethylmethylimidazole ethyl sulfate is used as sole antistatic additive.

In an embodiment, the antistatic agent is selected from Soyabean oil with C10 to C16 Carbon chains, 1-Ethyl-3-methyl imidazolium dicyanamide, alkali metal salts in solvent, phosphoric acid and triethyl ether, metallic salt and polyether.

### Plasticizer

In an embodiment, the TPU composition includes plasticizers. The plasticizers include tributyl O-acetyl citrate and triaryl phosphate isoproxyliert.

### Lubricants

In an embodiment, the TPU composition includes lubricants. Lubricants include esters of montanic acids.

### Isocyanate

In an embodiment, the isocyanate is selected from methylene diphenyl diisocyanate, polymeric methylene diphenyl diisocyanate or combination thereof.

The isocyanates are selected from aliphatic isocyanates, aromatic isocyanates, and a combination thereof. By the term “aromatic isocyanate”, it is referred to molecules having two or more isocyanate groups attached directly and/or indirectly to the aromatic ring. Further, it is to be understood that the isocyanate includes both monomeric and polymeric forms of the aliphatic and aromatic isocyanate. By the term “polymeric”, it is referred to the polymeric grade of the aliphatic and/or aromatic isocyanate comprising, independently of each other, different oligomers, and homologues.

In another embodiment, the isocyanate comprises an aromatic isocyanate selected from toluene diisocyanate; polymeric toluene diisocyanate, methylene diphenyl diisocyanate; polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate, tolidine diisocyanate, 1,3,5-triisopropyl benzene-2,4,6-triisocyanate and mixtures thereof. In other embodiment, the aromatic isocyanate is selected from toluene diisocyanate; polymeric toluene diisocyanate, methylene diphenyl diisocyanate; polymeric methylene diphenyl diisocyanate, m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate and 1-methyl-3,5-diethylphenylene-2,4-diisocyanate. In other embodiments, the aromatic isocyanate is selected from toluene diisocyanate; polymeric toluene diisocyanate, methylene diphenyl diisocyanate; polymeric methylene diphenyl diisocyanate, m-phenylene diisocyanate and 1,5-naphthalene diisocyanate or a combination thereof. In still other embodiment, the aromatic isocyanate is selected from toluene diisocyanate; polymeric toluene diisocyanate, methylene diphenyl diisocyanate and polymeric methylene diphenyl diisocyanate or mixture thereof.

In another preferred embodiment, the aromatic isocyanate selected from methylene diphenyl diisocyanate, polymeric methylene diphenyl diisocyanate or combination thereof.

In another preferred embodiment, the methylene diphenyl diisocyanate exists in three different isomeric forms, namely 2,2′-methylene diphenyl diisocyanate (2,2′-MDI), 2,4′-methylene diphenyl diisocyanate (2,4′-MDI) and 4,4′-methylene diphenyl diisocyanate (4,4′-MDI). Methylene diphenyl diisocyanates are classified into monomeric methylene diphenyl diisocyanate and polymeric methylene di-phenyl diisocyanate referred to as technical methylene diphenyl diisocyanate. Polymeric methylene diphenyl diisocyanate includes oligomeric species and methylene diphenyl diisocyanate isomers. Thus, polymeric methylene diphenyl diisocyanate may contain a single methylene diphenyl diisocyanate isomer or isomer mixtures of two or three methylene diphenyl diisocyanate isomers, the balance being oligomeric species. Polymeric methylene diphenyl diisocyanate tends to have isocyanate functionalities of higher than 2. The isomeric ratio as well as the amount of oligomeric species can vary in wide ranges in these products. For instance, polymeric methylene diphenyl diisocyanate may typically contain 30 wt.-% to 80 wt.-% of methylene diphenyl diisocyanate isomers, the balance being said oligomeric species. The methylene diphenyl diisocyanate isomers are often a mixture of 4,4′-methylene diphenyl diisocyanate, 2,4′-methylene diphenyl diisocyanate and very low levels of 2,2′-methylene di-phenyl diisocyanate.

In another preferred embodiment, the isocyanate comprises a polymeric methylene diphenyl diisocyanate. Commercially available isocyanates available under the tradename, such as, but not limited to, Lupranate® from BASF can also be used for the purpose of the present invention.

In another preferred embodiment, the aliphatic isocyanate is selected from isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, ethyl ester 1-lysine triisocyanate, 1,6,11-triisocyanatoundecane, (2,4,6-trioxotriazine-1,3,5 (2h,4h,6h)-triyl)tris(hexamethylene) isocyanate, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, triphe-nylmethane-4,4′,4″-triisocyanate, toluene-2,4,6-triyl triisocyanate, tris(isocyanatohexyl) biuret, trimethyl-cyclohexyl] triisocyanate, 2,4,4′-triisocyanato-dicyclohexylmethane, 2,2,-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(paraisocyano-cyclohexyl) sulfide, bis(para-isocyanato-cyclohexyl) sulfone, bis(para-isocyano-cyclohexyl) ether, bis(para-isocyanato-cyclohexyl) diethyl silane, bis(para-isocyanato-cyclohexyl) diphenyl silane, bis(para-isocyanato-cyclohexyl)ethyl phosphine oxide, bis(para-isocyanato-cyclohexyl) phenyl phosphine oxide, bis(para-isocyanato-cyclohexyl)N-phenyl amine, bis(para-isocyanato-cyclohexyl)N-methyl amine,3,3-diisocyanato adamantane, 3,3-diisocyano biadamantane, 3,3-diiso-cyanatoethyl-1′-biadamantane, 1,2-bis(3-isocyanato-propoxy) ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclo-hexane, 1,2-diisocyanato octadecane, 2,5-diisocyanato-1,3,4-oxadiazole, OCN(CH₂)₃O(CH₂)₂O(CH₂)₃NCO and OCN(CH₂)₃N(CH₃)(CH₂)₃NCO or polymeric forms of diisocyanates; the aliphatic isocyanate selected from isophorone diisocyanate, propylene-1,2-diisocyanate, propylene-1,3-diisocyanate, butylene-1,2-diisocyanate, hexamethylene-1,6-diisocyanate, 2-methylpentamethylene-1,5-diisocyanate1,5-pentamethylene diisocyanate, 1,6,11-triisocyanatoundecane, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane or polymeric forms of diisocyanates; and the aliphatic isocyanate is selected from isophorone diisocyanate, hexamethylene-1,6-diisocyanate, 2-methylpentamethylene-1,5-diisocyanate, 1,5-pentamethylene diisocyanate, 1octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane and polymeric forms of diisocyanates or mixtures thereof.

In an embodiment, the isocyanate is selected in range from a 2,2′-, 2,4′- and/or 4,4′-diisocyanate, a hexamethylene diisocyanate (HDI), or Hydrogenated MDI or a carbodiimide modified MDI, 4,4′-diphenylmethane diisocyanate, polymeric MDI, carbodiimide modified MDI, MDI prepolymer or combination thereof.

In another embodiment, the at least one isocyanate is with an isocyanate functionality ranging from 2.0 to 4.0.

In a preferred embodiment, the isocyanate comprises has an isocyanate functionality ranging from 1.5 to 3.0. In another preferred embodiment, the isocyanate functionality of the first isocyanate ranges from 1.6 to 3.0, or from 1.7 to 3.0, or from 1.8 to 3.0, or from 1.9 to 3.0. In another preferred embodiment, the isocyanate functionality of the isocyanate ranges from 1.9 to 2.9, or from 1.9 to 2.8, or from 1.9 to 2.7, or from 1.9 to 2.6, or from 1.9 to 2.5, or from 1.9 to 2.4. In another preferred embodiment, the isocyanate functionality of the isocyanate ranges from 1.90 to 2.30, or from 1.90 to 2.20.

In a preferred embodiment, the isocyanate has an isocyanate content in range from 25 wt. % to 55 wt. % of the Part A.

In a preferred embodiment, the isocyanate is in an amount in range from 1 wt.-% to 50 wt.-% of the Part A. In another preferred embodiment, the isocyanate is in an amount in range from 1 wt.-% to 40 wt.-%, or from 4 wt.-% to 40 wt.-%, or from 6 wt.-% to 40 wt.-%, or from 8 wt.-% to 40 wt.-% of the Part A. In another preferred embodiment, the isocyanate is in an amount in range from 10 wt.-% to 40 wt.-%, or from 10 wt.-% to 38 wt.-%, or from 10 wt.-% to 36 wt.-% of the Part A.

In another embodiment the isocyanate has viscosity at 25° C. in range from 20 to 100 cps determined according to DIN EN ISO 3219.

In another embodiment, the isocyanate includes a mixture of at least two different isocyanates.

In one embodiment, the isocyanate comprises a mixture of a first isocyanate and a second isocyanate. The weight ratio between the first isocyanate and the second isocyanate in the isocyanate composition is in the range from 2.0:1.0 to 1.0:2.0. In another embodiment, the weight ratio between the first isocyanate and the second isocyanate in the isocyanate composition is in the range from 2.0:1.0 to 1.0:1.5 or from 2.0:1.0 to 1.0:1.3, or from 2.0:1.0 to 1.0:1.0. In another embodiment the weight ratio between the first isocyanate and the second isocyanate in the isocyanate composition is in the range from 1.9:1.0 to 1.0:1.0, or from 1.8:1.0 to 1.0:1.01, or from 1.7:1.0 to 1.0:1.0.

In an embodiment, the isocyanate composition may also comprise one or more solvents. Suitable solvents are known to those skilled in the art. Suitable examples are nonreactive solvents such as ethyl acetate, methyl ethyl ketone and hydrocarbons.

### Part B

TPU composition is prepared from the reaction mixture comprising Part A and Part B. The Part B includes at least one lignin component. In an embodiment, the at least one lignin component is in the range of 10.0 wt. % to 60.0 wt. % of the total reaction mixture.

### Lignin

Lignin is a natural polymer found in wood and in the secondary cell walls of plants and some algae. It is formed from oxidative coupling of primarily 4-hydroxyphenylpropanoids (coniferyl alcohol, sinapyl alcohol, and coumaryl alcohol), therefore is the second most abundant biopolymer on Earth. Because of its polyphenolic structure, lignin shows antimicrobial, antioxidant, fungicidal and photoinhibition properties. The multifunctional behaviour of lignin cannot be found in a single lignin as a result of the significantly variable polymerization route of lignins creating poly-disperse polyphenolic structures in different environment. Thus, the properties of lignin are significantly affected by the source plants and methods of lignin extraction. The heterogeneity in molecular size, bond energies, and functional group distribution are the complicating factors for lignin. Lignin and lignin derivatives have been used in making composites and coatings because of its particle size, hydrophobicity, and ability to form stable mixtures.

The term “lignin” as used herein refers to a polymer found in woody plants, trees and crops and residues. Commercial lignin is generally produced as a by-product of the pulp and paper industry and is separated from the wood by a chemical pulping process. Lignin is available in form of raw lignin and chemically treated lignin.

In an embodiment, the raw lignin includes any unreacted lignin, a water treated lignin, any lignin that is not chemically treated, lignin not containing any foreign chemicals (such as sulfonates or other chemicals), any plant material (such as hardwood lignin, softwood lignin, grass lignin, straw lignin, and bamboo lignin), nut feedstock (such as fine powders such as pecan bark, walnut bark, peanut bark), Seed ingredients (e.g., fine powders such as cotton seed bark), etc. Raw lignin is generally obtained from plants, trees, and/or crops.

In an embodiment, the chemically treated lignin includes the lignin as obtained from Kraft lignin (produced in the Kraft pulping/sulfate process), soda lignin (generated in the soda pulping process); Lignin sulphonates produced in the sulfite pulping process; Organosolv lignins due to solvent extraction; Hydrolysed lignin produced by biomass hydrolysis; Lignin obtained from the ethanol process (through acid treatment) and combinations thereof. The chemically treated lignin obtained in the Kraft pulp process is generally not water-soluble. However, the chemically treated lignin also includes sodium or potassium salt of lignin and is generally water-soluble and is in liquid form.

In an embodiment, the lignin includes raw lignin, chemically treated lignin, or a combination thereof.

In a preferred embodiment, the TPU composition includes raw lignin. In another preferred embodiment, the TPU composition includes a combination of both raw/unreacted lignin and reacted lignin.

In a more preferred embodiment, the TPU composition includes a raw lignin.

In an embodiment, the raw lignin is selected from a hardwood lignin, a softwood lignin, a grass lignin, a switch grass lignin, or combination thereof.

In a preferred embodiment the lignin is a hardwood lignin. The hardwood lignin includes the lignin from red maple.

In an embodiment, the lignin component has an average particle size in range from 10 to 40 μm analysed by a Malvern Mastersizer® 3000 Particle Size Analyzer in dry powder mode. The method of calculating the average particle size of the lignin component analysed by a Malvern Mastersizer® 3000 Particle Size Analyzer in dry powder mode is provided below in Method D. In a preferred embodiment, the average particle size is in range from 15 to 35 μm.

In a preferred embodiment, the Part B with lignin constitutes 0.1 to 60 wt. % of the reaction mixture. In another preferred embodiment, the reaction mixture of the TPU composition includes the Part B with lignin in amount in range from 1.0 to 60.0 wt. %, or from 5.0 to 60.0 wt. %, or 10.0 to 60.0 wt. % or from 15.0 to 60.0 wt. %, or from 20.0 to 60.0 wt. %. In a furthermore preferred embodiment, the reaction mixture of the TPU composition includes the Part B with lignin in amount in range from 20.0 to 55.0 wt. %, or from 20.0 to 50.0 wt. %. In most preferred embodiment, the reaction mixture of the TPU composition includes the Part B with lignin in amount in range from 30.0 to 50.0 wt. %.

In an embodiment, the ratio of Part A:Part B of the reaction mixture is in range in range from 99:1 to 1:1.5.

### Method of Forming TPU Composition:

Method 1: Part A Pallet Extruded with Part B Lignin.

Another aspect of the present invention is directed towards a first method of forming the TPU composition, the process comprising:
a. mixing the components, i.e. the at least one isocyanate reactive component, the at least one isocyanate and optionally at least one additive of Part A;
b. adding the at least one lignin component of the Part B to mixed components of the Part A in step a. to form the reaction mixture;
c. optionally heating the reaction mixture.

In an embodiment, the mixing is performed by a mixing device. The mixing device is a low pressure or high-pressure mixing device comprising:
pumps to feed the streams,
a high-pressure mixing head in which the Part A and Part B, as described hereinabove, are mixed,
a feed line A fitted to the high-pressure mixing head through which the Part A stream is introduced into the mixing head, and
a feed line B fitted to the high-pressure mixing head through which the Part B is introduced into the mixing head.

Optionally, the mixing device, as described hereinabove, can further comprise at least one measurement and control unit for establishing the pressures of each feed lines in the mixing head. Also, the term “low pressure” here refers to a pressure in between 0.1 Mpa to 5 Mpa, while the term “high pressure” refers to pressure above 5 Mpa.

In one embodiment, before mixing into the mixing device, the Part A and Part B, independent of each other, are pre-mixed in suitable mixing means, such as, but not limited to, a static mixer.

In an embodiment, the first method of obtaining the TPU composition includes premixing the components of the Part A, i.e. at least one isocyanate reactive component, the at least one isocyanate and optionally at least one additive with high shear force before mixing with the Part B.

Suitable temperatures for processing the reaction mixture are well known to the person skilled in the art. In an embodiment the mixing is performed at a temperature in range from 40° C. to 250° C.

In another embodiment, the Part A and the Part B of the reaction mixture are passed from the same or separate mixing head into the mixing device with or without pressure. A solid/gas mixture is added through additional inlets. By “solid”, it is referred to the fillers, as described hereinabove, which are in a solid state of matter.

In an embodiment. The mixing in the METHOD 1, i.e. the first method is performed with a screw extruder. The screw extruder includes single screw extruder and a twin screw extruder. In a preferred embodiment, the mixing is performed by a twin screw extruder. Twin screw extruders include Bühler PolyTwin, EcoTwin and CompacTwin twin-screw extruders and Buehler 2-axis-screw extruder BTSK 20/40 D. In an embodiment, the twin screw extruder includes screw selected from counter rotating screws and corotating screws.

Method 2: Part A Components Mixed with Part B Lignin.

Another aspect of the present invention is directed towards a second method of forming the TPU, the second method comprising the steps of:
a. providing the at least one lignin component of Part B and the isocyanate reactive component of Part A, wherein the isocyanate reactive component of Part A includes at least one polyol and at least one chain extender;
b. mixing the at least one lignin component of Part B and the isocyanate reactive component of Part A to form a premix;
c. mixing the premix of step b. with the at least one isocyanate of Part A to form the TPU composition.

Suitable temperatures for processing the reaction mixture are well known to the person skilled in the art. In an embodiment the mixing is performed at a temperature in range from 40° C. to 250° C. In another embodiment, the mixing is performed at a temperature in range from 50° C. to 250° C., or from 50° C. to 200° C., or from 50° C. to 150° C., or 50° C. to 100° C.

In an embodiment, the premix is mixed with the at least one isocyanate at a temperature in range from 50° C. to 85° C.

In another embodiment, the mixing of the at least one isocyanate of the Part A with the premix is done after 6 to 24 hrs of formation of the premix.

In an embodiment, for the first method and/or the second method the isocyanate reactive component includes at least one polyol, at least one chain extender, and optionally at least one additive. The at least one additive includes an antioxidant, a mold release agent, a lubricant, a plasticiser, a hydrolysis stabilizer, an anti-blocking agent, a light stabilizer, a cross linker, a catalyst, a flame retardant, a rheology additive, a defoamer, a friction reducer, an antistatic agent, a surfactant, and other components, or combination thereof. In a preferred embodiment, the at least one additive includes an antioxidant.

In an embodiment, for the first method and/or the second method, the TPU composition is prepared by melt compounding process.

In another embodiment, for the first method and/or the second method, the TPU composition is prepared by one shot process.

In another embodiment, for the first method and/or the second method, the TPU composition is prepared by belt line production process.

In another embodiment, for the first method and/or the second method, the reaction mixture obtained from the mixing device is fed to a means to provide shape to the TPU composition. The means to provide shape includes but is not limited to spraying, spray molding, injection molding, etc.

In another embodiment, for the first method and/or the second method, the reaction mixture is cured at room temperature for 24 hours. In another embodiment, the reaction mixture is further cured at 80° C. for 24 hours.

### TPU

The properties of the TPU composition and articles made thereof may vary within wide ranges according to the application. In one embodiment, the TPU composition and articles made thereof has a Shore A hardness ranging from 10.0 A to 100.0 A, determined according to ASTM D2240-15e1. In an embodiment, the Shore A hardness of the TPU is from 20.0 A to 100.0 A, or from 30.0 A to 100.0 A. In another embodiment, the TPU has a shore A hardness in range from 60.0 A to 100.0 A or from 70.0 A to 100.0 A.

In an embodiment, the TPU composition and articles made thereof are associated with the abrasion loss in range from 1.0 to 150.

In another embodiment, the TPU composition and articles made thereof have improved slip resistance, squeaking, viscosity, density, gloss, MFI value, tensile strength, strain at break, glass transition temperature, Cold flex failure value, modulus value, and coefficient of friction.

The TPU composition is a sustainable and cost-effective solution for low gloss, matt finish surfaces for consumer electronics and outsole applications.

### Article and Use

Another aspect of the present invention is directed to an article prepared by the TPU composition as disclosed and by the TPU obtained by the METHOD 1 as well as METHOD 2.

Another aspect of the present invention is directed to use of the TPU composition as disclosed and by the TPU obtained by the METHOD 1 as well as METHOD 2.

Another aspect of the present invention is directed to use of the TPU composition in preparing shoe soles, floor coverings, footwears, gloves, jackets, garments, garment linings, hats, aprons, scarfs, coats, appliances, consumer electronics, handwares, furniture, cleat plate, conduits, tubes, hoses, and parts thereof.

Another aspect of the present invention is directed to the uses of the TPU composition in preparing an outsole of the footwear.

In another aspect, the presently claimed invention is directed to an article (100) comprising
at least one receiving unit (101) configured to receive an appendage of a user;
optionally at least one outsole (103); and
optionally at least one insole (102) configured to support the appendage and disposed
between the at least one receiving unit (101) and the at least one outsole (103), wherein the at least one receiving unit (101), the at least one insole (102) and/or the at least one outsole (103) is formed of the TPU composition as described hereinabove.

In an embodiment, the user includes a human being and an animal with the appendage including hands and legs with or without digits.

In another embodiment, the at least one receiving unit (101) is configured to receive appendage of the user. In a preferred embodiment, the receiving unit (101) receives foot of the user or a hand of the user.

In an embodiment, the article includes the at least one insole (102) formed of the TPU composition as described hereinabove.

In an embodiment, the article includes the at least one outsole (103) formed of the TPU composition as described hereinabove.

In an embodiment, the article includes a garment, a footwear, a handwear, a glove, and a floor covering.

In preferred embodiment, the article is the footwear. The footwear includes a sandal, a shoe, a loafer, a boot, a sneaker and a stiletto.

In another preferred embodiment, the article is the handwear. The handwear includes a glove, a kote, glovelette

In another preferred embodiment, the article is a floor covering. The floor covering includes a mattress or a carpet.

### Methods of Determination of Parameters

### Method A: Slip Resistance

The slip resistance is measured by METHOD A. The testing was based on the DIN EN ISO 8295.

The sample to be tested is placed on a flat target test surface in order to achieve a uniform contact pressure. A certain uniaxial force applied on the sample. The force required to displace the surfaces against each other is then recorded. The tests are performed at a constant linear velocity.

The static coefficient of friction is obtained from the static friction force, which is the maximum force value when the sample is stationary, and the normal force exerted by the mass of the sled and the additional weight.

The dynamic friction coefficient is obtained rather from the dynamic friction force, which is the average force when the sample is moving, and the normal force exerted by the mass of the sled and the additional weight.

### Method B: Squeak Test

The squeaking was measured by Method B.

The squeak testing determines frequencies and pressures of sound generated by the TPU/lignin composite sample (or any polymers) surface against an abrading surface during an event of abrasion at certain speeds and loads. Discs of TPU (16×4 mm2) samples were mounted on a vertical cylinder with certain loads. The vertical cylinder can exert angular force and normal force on the TPU samples against an abrading platform which also rotate counter-clockwise. The rotation speed of the cylinder, normal load and the rotation speed of the abrading platform is varied in order to observe the effect of angular motion and force on the sound generation of TPU samples against the abrading platform. The sound pressure and frequencies are recorded by an environmental noise meter. The squeak noise is characterized by four different test modes as explained in the figure; each mode exposes the TPU sample to different angular motion and force which are critical to replicate the squeak generation by the human locomotion.

Method includes test Modes A, B, C, and D defined as:
a. Mode A test the effect of normal load and linear abrasion on the squeaking.
b. Mode B test the effect of angular speed of the normal load on squeaking of TPU
c. Mode C tests the effect of rotational speed of the abrading medium on the squeaking of TPU.
d. Mode D tests the effect of combined normal and angular forces on the squeak generation by TPU samples.

### Method C: Viscosity

The viscosity is measured by Method C.

Capillary rheometer was used to study the dynamic viscosity of TPU and lignin compounds. ASTM D3835-16 was used as the standard for testing of TPU/lignin compounds. The dynamic viscosity was measured as the function of temperature and shear rates.

### Method D: Average Particle Size

The average particle size of lignin component is calculated by the Method D.

The brown powder sample was analyzed for particle size using a Malvern Mastersizer® 3000 Particle Size Analyzer* (Malvern Instruments, Southborough, MA) in dry powder mode. Results are reported in terms of a volume-weighted mean diameter D [4,3]. The diameter at which 10%, 50%, and 90% of the population is smaller is given as d(0.1), d(0.5), and d(0.9). Surface statistics are based on an estimated particle density of 1.0 g/cm3

The Mastersizer® 3000 uses laser diffraction, also called Mie scattering to measure particles in the range of 0.01-3000 μm. In dry powder mode, the instrument uses a single source: a red Helium Neon Laser to measure forward scattering, side scattering, and backscattered signals. The sample is dispersed using an Aero S dry powder dispersing unit and operations are performed using a standard operating procedure (SOP) created specifically to include such sample parameters as refractive index, air pressure, analysis time, and number of measurements.

### Advantages

The TPU composition is associated with significantly improved physical characteristics as improved wet slip resistance, reduced squeaking noise effect, antioxidant effect, improved flame retardancy, very low gloss. The TPU composition is able to use both raw/unreacted lignin as well as chemically treated/modified lignin thereby reducing the cost of raw materials. The TPU composition is able to achieve the improved physical characteristics with significantly higher quantity of lignin irrespective of the type of lignin. I.e. Raw and unreacted lignin impart similar properties to the TPU composition

### Applications

Improved physical properties of the TPU composition including improved wet slip resistance render the TPU composition suitable for usage for footwear, clothing, pipe manufacturing, furniture, jackets, garments, garment linings, hats, aprons, scarfs, coats, appliances, consumer electronics, handwares, furniture, cleat plate, and parts thereof. Wet slip resistance improvement is especially suitable for footwears, in shoe soles, handwear, gloves, floor coverings and parts thereof.

The presently claimed invention is illustrated in more detail by the following embodiments and combinations of embodiments which results from the corresponding dependency references and links:
I. A thermoplastic polyurethane (TPU) composition prepared from a reaction mixture comprising:
   a. Part A including
      i. at least one isocyanate reactive component;
      ii. at least one isocyanate in range of 15 wt. % to 45 wt. % of Part A; and
   b. Part B including at least one lignin component;
   wherein the at least one isocyanate reactive component includes at least one polyol, at least one chain extender and optionally at least one additive,
   wherein the at least one additive is in range of 0.40 wt. % to 25.00 wt. % of Part A and the at least one chain extender in range of 1.0 wt. % to 10.0 wt. % of Part A.
II. The TPU composition of embodiment I, wherein the at least one polyol has an average functionality in the range of 2.0 to 8.0, the hydroxyl number in the range of 20 mg KOH/g to 800 mg KOH/g and the nominal molecular weight in the range of 200 g/mole to 6000 g/mole.
III. The TPU composition of any one of embodiments I or II, wherein the at least one polyol is selected from polyether polyols, polyester polyols, polyetherester polyols, polytetrahydrofuran, polyester diol, or a combination thereof.
IV. The TPU composition of any one of embodiments I to III, wherein the reaction mixture includes at least two polyols, or at least three polyols.
V. The TPU composition of any one of embodiments I to IV, wherein the at least one lignin component is in the range of 1.0 wt. % to 60.0 wt. % of the reaction mixture.
VI. The TPU composition of any one of embodiments I to V, wherein the at least one lignin component has average particle size in range from 10 to 40 μm analysed by a Malvern Mastersizer® 3000 Particle Size Analyzer in dry powder mode.
VII. The TPU composition of any one of embodiments I to VI, wherein the at least one lignin component is selected from a raw lignin, a chemically treated lignin, or combination thereof.
VIII. The TPU composition of any one of embodiments 1 to VII wherein the at least one lignin component is a raw lignin.
IX. The TPU composition of any one of embodiments I to VIII, wherein the at least one additive includes an antioxidant, a mold release agent, a lubricant, a plasticiser, a hydrolysis stabilizer, an anti-blocking agent, a light stabilizer, a cross linker, a catalyst, a flame retardant, a rheology additive, a defoamer, a friction reducer, an antistatic agent, a surfactant, and other components, or combination thereof.
X. The TPU compositions of any one of embodiments I to IX, wherein the TPU has a shore A hardness is in range from 70 to 100 determined by ASTMD2240 or the abrasion loss in range from 1.0 to 150.
XI. A first method of forming the TPU composition of embodiment I, the method comprising:
   a. mixing the at least one isocyanate reactive component and the at least one isocyanate of Part A;
   b. adding the at least one lignin component of the Part B to mixed components of the Part A in step a. to form the reaction mixture;
   c. optionally heating the reaction mixture.
XII. A second method of forming a TPU composition of embodiment I, the method comprising:
   a. providing the at least one lignin component of Part B and the isocyanate reactive component of Part A,
   wherein the isocyanate reactive component of Part A includes at least one polyol and at least one chain extender;
   b. mixing the at least one lignin component of Part B and the isocyanate reactive component of Part A to form a premix;
   c. mixing the premix of step b. with the at least one isocyanate of Part A to form the TPU composition.
XIII. The method of embodiment XII, wherein the premix is formed at a temperature in range from 40° C. to 250° C.
XIV. The method of any one of embodiments XII or XIII, wherein the premix is mixed with the at least one isocyanate at a temperature in range from 50° C. to 100° C.
XV. The method of any one of embodiments XI to XIV, wherein the isocyanate reactive component of Part A includes at least one polyol, at least one chain extender, and optionally at least one additive including an antioxidant, a mold release agent, a lubricant, a plasticiser, a hydrolysis stabilizer, an anti-blocking agent, a light stabilizer, a cross linker, a catalyst, a flame retardant, a rheology additive, a defoamer, a friction reducer, an antistatic agent, a surfactant, and other components, or combination thereof.
XVI. The method of any one of embodiments XI to XV, wherein the TPU composition is prepared by a melt compounding process.
XVII. The method of any one of embodiments XI to XVI, wherein the TPU composition is prepared by a one-shot process.
XVIII. The method of any one of embodiments XI to XVII, wherein the TPU composition is prepared by a belt line production process.
XIX. The method of any one of embodiments XI to XVIII, wherein the mixing is performed with a screw extruder.
XX. An article prepared formed of the TPU composition of any one of the preceding embodiments or prepared by the method of any of the preceding embodiments.
XXI. Use of the TPU composition of any one of the preceding embodiments or prepared by the method of any preceding embodiments, in preparing shoe soles, floor coverings, footwears, gloves, jackets, garments, garment linings, hats, aprons, scarfs, coats, appliances, consumer electronics, handwares, furniture, cleat plate, conduits, hose, tubes, and parts thereof.
XXII. Use of the TPU composition of any of the preceding embodiments or prepared by the method of any preceding embodiments, in preparing an outsole (103) of the footwear.
XXIII. The TPU composition of any of the preceding embodiments, wherein the lignin includes a raw lignin, a modified lignin or a combination thereof.
XXIV. The TPU composition of any of the preceding embodiments, wherein the lignin includes a combination of raw lignin and a modified lignin.
XXV. The TPU composition of any of the preceding embodiments, wherein the lignin includes a raw lignin.
XXVI. An article (100) comprising
   at least one receiving unit (101) configured to receive an appendage of a user;
   optionally at least one outsole (103); and
   optionally at least one insole (102) configured to support the appendage and disposed
   between the at least one receiving unit (101) and the at least one outsole (103), wherein the at least one receiving unit (101), the at least one insole (102) and/or the at least one outsole (103) is formed of the TPU composition of any one of preceding embodiments or prepared by method of any one of preceding embodiments.
XXVII. The article (100) of embodiment XXVI, wherein the at least one insole (102) is formed of the TPU composition of any one of preceding embodiments or prepared by method of any one of preceding embodiments.
XXVIII. The article (100) of embodiment XXVI or XXVII, wherein the at least one outsole (103) is formed of the TPU composition of any one of preceding embodiments or prepared by method of any one of preceding embodiments.
XXIX. The article (100) of any one of embodiment XXVI to XXVIII, wherein the article (100) includes a garment, a footwear (100a), a handwear (100b), a glove, and a floor covering.
XXX. The article (100) of any one of embodiment XXVI to XXIX, wherein the article (100) is the footwear (100a).
XXXI. The article (100) of any one of embodiment XXVI to XXIX, wherein the article (100) is the handwear (100b).

### EXAMPLES

The presently claimed invention is illustrated by the non-restrictive examples which are as follows:

The TPU composition as claimed was prepared by mixing the Part A and Part B components. Details of the actual components of Part A and Part B are listed in the Table 1 of Raw materials.

TABLE 1
RAW MATERIALS
POLYOL

| | |
|---|---|
| Pol 1 | PTHF1000 (90042) \| Polytetrahydrofurane of Molecular Weight/Mol from 975 to |
| | 1025, Hydroxyl number of 109.5 to 115.1 mgKOH/g, Glass transition point Tg - |
| | 77° C. |
| Pol 2 | PTHF 2000 (90580) \| Polytetrahydrofurane of Molecular Weight/Mol from 1950 |
| | to 2050, Hydroxyl number of 54.7 to 57.5 mgKOH/g, Glass transition point Tg - |
| | 77° C. |
| Pol 3 | Polyol 90230 \| Polyol with activators, does not contain ethyl alcohol, does not |
| | contain ozone-depleting substances (BASF POLYURETHANI ITALIA SPA) |
| Pol 4 | Polyesterol Molar mass: 2952.63 g/mol, Polyester polyol based on Adipate DS/MEG |
| | and B14 diol, Mol wt. 3000 g/mol, OH value 38 mg/g, Viscosity @ 75° C. |
| | 1550 mPas. acid no 0.5 mg/g |
| Pol 5 | Polyester polyols of Ads and B14: Nominal Functionality: 2, OH Number (avg.) |
| | 45.5, Nominal Molecular Weight (g/mole) 2440 g/mol, Viscosity @ 75° C. 1080 |
| | mPas, Acid No. (max): 0.6 mg/g |
| Pol 6 | Polyester polyols based on ADS and B14 diol, needed: Nominal Functionality: 2, |
| | OH Number (avg.) 56. mg/g, Nominal Molecular Weight (2000 g/mole), Viscosity |
| | @ 75° C. 670 mPas, Acid No. 0.25 mg/g |
| Pol 7 | Lupraphene 1010 |
| Pol | (2-Oxepanone, polymer with 2,2-dimethyl-1,3-propanediol), Polyester diol |
| 8/Diol | derived from caprolactone monomer, terminated by primary hydroxyl groups, OH |
| | value 54-58 mg KOH/g, acid value max 0.25 mg KOH/g, CAS No. 69089-45-8 |

ISOCYANATE

| | |
|---|---|
| ISO 1 | Lupranat MES |
| ISO 2 | Iso MMDI (92640) \|MDI, Mol wt. 521 |
| ISO 3 | (2,4-monomeric MDI), Iso MMDI \| 4,4′ Diphenylmethane Diisocyanate, NCO |
| | content 35 wt.-%, Viscosity @ 25° C., cps - 33, Molar mass 250.255 g/mol |

CHAIN EXTENDER

| | |
|---|---|
| KV1 | Butanediol 1,4 \| 1,4-Butanediol, Molar Mass (90.12 g/mol) |
| KV2 | Ethyenglykol \| Ethyleneglycol, Molar Mass |
| KV3 | MEG \| Monoethylenglykol, Molar Mass 62.07 g/mol |

ANTI-OXIDANT

| | |
|---|---|
| AntOx 1 | Blend of 2 phenolic Antioxidants: a pentaerythritol tetrakis[3-[3,5-di-tert-butyl-4- |
| | hydroxyphenyl]propionate and a N,N′-(hexane-1,6-diyl)bis[3-(3,5-di-tert-butyl-4- |
| | hydroxyphenyl) propenamide]. |
| AntOx 2 | (Pentaerythritol tetrakis[3-[3,5-di-tert-butyl-4-hydroxyphenyl]propionate) |

MOLD RELEASE AGENT/ADDITIONAL LUBIRICANT

| | |
|---|---|
| MRA | Ethylene-bis-stearamide Microbeads |

LUBRICANT

| | |
|---|---|
| Lub | Ester of montanic acids with multifunctional alcohols. Montanic acids in raw |
| | montan wax are straight chain, unbranched monocarboxylic acids with a chain |
| | length in the range of C28-C32 |

PLASTICIZER

| | |
|---|---|
| Plast | Tributyl O-acetyl citrate, CAS Registry Number: [77-90-7] |

HYDROLYSIS STABILIZER

| | |
|---|---|
| Hyd Stab | Benzene, 1,3-bis(1-isocyanato-1-methylethyl)-, homopolymer, polyethylene |
| | glycol mono-Me-ether-blocked, CAS NUMBER 197098-60-5, Molar Mass 359 g/mol |

HALS (LIGHT STABILIZERS)

| | |
|---|---|
| LStab | Chisorb 622 \| Chisorb 622 LT (Hindered Amine Light Stabilizer) |

UV LIGHT ABSORBER

| | |
|---|---|
| UVLA 1 | Oxanilide UV absorber, Ethane diamide, N-(2-ethoxyphenyl)-N′-(2-ethylphenyl), |
| | CAS No. 23949-66-8, Molecular wt. 312 g/mol |
| UVLA 2 | UV absorber of the hydroxyphenyl-benzotriazole class, CAS No. 25973 - 55 - 1, |
| | Chemical formula: 2-(2H-benzotriazol-2-yl)-4, 6-ditertpentylphenol, Molecular |
| | Wt. 351.5 |

FLAME RETARDANT

| | |
|---|---|
| FHF | A halogen free, flame-retardant additive, comprises salt of melamine and cyanuric |
| | acid, molecular weight 255.19 g/mol, solid powder. |
| W | Triaryl phosphate isoproxyliert, flash point 500° C., phosphorus content 9.1%, |
| | Viscosity @ 20° C. 46 mPas, acid value 0.1 mg/g. |

ADDITIVE

| | |
|---|---|
| Add 1 | Acetyltributylcitrate |

### General Process of Forming the Part A

The Part A of the reaction mixture was prepared in a large variety as listed in variations of Part A (i.e. A1 to A11). Tables 2 and 3 provide the actual components of the variations of Part A (i.e. A1 to A11). Each component of the variations of Part A are defined by the actual weight and c. % value (total of which is 100 c. %).

TABLE 2
COMPONENTS OF PART A: A1 TO A5

| | A1 | A2 | A3 | A4 | A5 |
|---|---|---|---|---|---|
| Pol 1 | 1000 g \| | 292.46 g \| | 500 g \| | 1000 g \| | 1000 g \| |
| | 53.59 (wt. %) | 29.24 (wt. %) | 34.40 (wt. %) | 61.40 (wt. %) | 53.33 (wt. %) |
| Pol 2 | — | 292.46 g \| | 500 g \| | — | — |
| | | 29.24 (wt. %) | 34.40 (wt. %) | | |
| Pol 3 | — | 38.57 g \| 3.85 | 65.94 g \| | — | — |
| | | (wt. %) | 4.53 (wt. %) | | |
| ISO 1 | — | — | — | 520 g \| | 700 g \| 37.33 |
| | | | | 31.93 (wt. %) | (wt. %) |
| ISO 2 | — | 217.59 g \| | 372 g \| | — | — |
| | | 21.75 (wt. %) | 25.59 (wt. %) | | |
| ISO 3 | 425 g \| 22.78 | — | — | — | — |
| | (wt. %) | | | | |
| KV1 | — | — | — | 97.13 g \| | 161.95 g \| |
| | | | | 5.96 (wt. %) | 8.63 (wt. %) |
| KV2 | 43.28 g \| | — | — | — | — |
| | 2.32 (wt. %) | | | | |
| AntOx 1 | — | 8.49 g \| 0.84 | 14.52 g \| | 11.39 g \| 0.7 | 13.12 g \| 0.7 |
| | | (wt. %) | 0.99 (wt. %) | (wt. %) | (wt. %) |
| AntOx 2 | 9.32 g \| 0.5 | — | — | — | — |
| | (wt. %) | | | | |
| MRA | — | 0.40 g \| 0.04 | 0.7 g \| | — | — |
| | | (wt. %) | 0.048 (wt. %) | | |
| Lub | 5.59 g \| 0.3 | — | — | — | — |
| | (wt. %) | | | | |
| Plast | 373.13 g \| 20 | 150 g \| 15 | — | — | — |
| | (wt. %) | (wt. %) | | | |
| LStab | 3.73 g \| 0.2 | — | — | — | — |
| | (wt. %) | | | | |
| UVLA 1 | 5.59 g \| 0.3 | — | — | — | — |
| | (wt. %) | | | | |
| Total | 1865.67 g \| | 1000 g \| 100 | 1453.16 g \| | 1628.53 g \| | 1875.084 g \| |
| | 100 (wt. %) | (wt. %) | 100 (wt. %) | 100 (wt. %) | 100 (wt. %) |

TABLE 3
COMPONENTS OF PART A: A6 TO A11

| | A6 | A7 | A8 | A9 | A10 | A11 |
|---|---|---|---|---|---|---|
| Pol 4 | 1000 g \| | 1000 g \| | — | — | — | — |
| | 66.38 | 66.38 | | | | |
| | (wt. %) | (wt. %) | | | | |
| Pol 5 | — | — | 1000 g \| | — | — | — |
| | | | 66.66 | | | |
| | | | (wt. %) | | | |
| Pol 6 | — | — | — | 1000 g \| | — | — |
| | | | | 64.00 | | |
| | | | | (wt. %) | | |
| Pol 7 | — | — | — | — | 1000 g \| | — |
| | | | | | 60.82 | |
| | | | | | (wt. %) | |
| Pol 8 | — | — | — | — | — | 59.67 g \| |
| | | | | | | 59.67 |
| | | | | | | (wt. %) |
| ISO 1 | — | — | — | 440 g \| | 535 g \| | — |
| | | | | 28.16 | 32.54 | |
| | | | | (wt. %) | (wt. %) | |
| ISO 3 | 230.14 g | 230.14 g \| | 390 g \| | — | — | 31.19 g \| |
| | \| 15.27 | 15.27 | 25.99 | | | 31.19 |
| | (wt. %) | (wt. %) | (wt. %) | | | (wt. %) |
| KV1 | — | — | 102.06 g \| | 111.62 g \| | 101.12 g \| | 8.61 g \| |
| | | | 6.80 | 7.14 | 6.15(wt. %) | 8.61 |
| | | | (wt. %) | (wt. %) | | (wt. %) |
| KV3 | 34.67 g \| | 34.67 g \| | — | — | — | — |
| | 2.30 | 2.30 (wt. %) | | | | |
| | (wt. %) | | | | | |
| AntOx 1 | 3.01 g \| | 3.01 g \| | — | — | — | — |
| | 0.2(wt. %) | 0.2(wt. %) | | | | |
| MRA | — | — | — | — | — | 0.05 g \| |
| | | | | | | 0.05 |
| | | | | | | (wt. %) |
| Lub | 4.52 g \| | 4.52 g \| 0.3 | — | — | — | — |
| | 0.3 | (wt. %) | | | | |
| | (wt. %) | | | | | |
| Plast | 225.94 g | 225.94 g \| | — | — | — | — |
| | \| 15 | 15 (wt. %) | | | | |
| | (wt. %) | | | | | |
| HyStab | 8 g \| | 8 g \| 0.53 | 8 g \| 0.53 | 10 g \| 0.64 | 8 g \| 0.48 | 0.47 g \| |
| | 0.53 | (wt. %) | (wt. %) | (wt. %) | (wt. %) | 0.47 |
| | (wt. %) | | | | | (wt. %) |
| ABA | — | — | — | 0.78 g \| | — | — |
| | | | | 0.05(wt. %) | | |
| Total | 1506.29 | 1506.29 g \| | 1500.06 g \| | 1562.4 g \| | 1644.12 g \| | 99.99 g \| |
| | g \| 100 | 100 (wt. %) | 100 (wt. %) | 100 (wt. %) | 100 (wt. %) | 100 |
| | (wt. %) | | | | | (wt. %) |

General Method of Forming the TPU with Part A and Part B:

The reaction mixture of the TPU composition was prepared by mixing different wt. % of Part B (i.e. lignin 0 wt. %, 20 wt. %, 30 wt. % and 50 wt. %) with corresponding wt. % of Part A (i.e. 100 wt. %, 80 wt. %, 70 wt. % and 50 wt. % of Part A variations, A1 to A11) as listed in Examples 1 to 40. The lignin used is raw lignin/hardwood lignin from maple. The physical properties of the Examples E1 to E40 were measured based on the standard methods listed in Table 4 below.

All samples were extruded in a twin screw extruder where pellets of Part A were melted and mixed with Part B (i.e. lignin powders). Pellets of Part A+Part B were used for molding and testing. The temperature of extrusion was 180 to 200° C. with a screw rpm of 200 to 400 rpm and throughput of 8 kg/hr.

TABLE 4
STANDARD METHOD

| DIN 53240-1 | OH value |
|---|---|
| Shore A Hardness | ASTMD2240 |
| | Shore hardness is tuned by varying the lignin content, hard phase |
| | content, chain length of polyol and type of polyols. Increasing |
| | lignin content increases the hardness of the TPU/lignin |
| | composites. Both soft and hard TPUs are obtained. |
| Density (Pellets) | ASTM D792 |
| Density (Plaques) | ASTM D792 |
| Abrasion Loss (mm3) | ASTM D5963 \| DIN53516 |
| | The abrasion loss increases with increasing lignin content. |
| | However, by varying TPU matrices and lignin content, abrasion loss |
| | is tuned. |
| Gloss (20°/Gloss | ASTM D523 |
| (60°) | Used to test gloss values at the flat surface of TPU/lignin molded |
| | samples at 20 and 60°. |
| | The gloss value at 20 and 60 degree decreases significantly with |
| | increasing lignin content. 50 wt. % lignin containing samples |
| | showed lowest gloss values. |
| MFI | ASTM D1238 |
| (170)/(180)/(190)/(210) | |
| Tensile Strength | ASTM D412 |
| (MPa) | |
| Cold Flex Failure (@ | −10 C./90° bend, DIN53543 |
| 50k cycle) | |
| Mode A/B/C/D | No squeaking was observed in 30 and 50 wt. % Lignin containing |
| | composites. |
| MFR (Melt flow rate) | DIN ISO 1122: 2016, No significant effect on MFR until 20 wt. % |
| Standard Tensile Test | DIN 53 504: 2016 |
| (TS) | |
| Strain at break St (%) | ASTM D412 |
| Tg (On set, ° C.) DSC | ASTM D3418-21 |
| Tg (I, ° C.) DSC | ASTM D3418-21 |
| Tg (Off set, ° C.) DSC | ASTM D3418-21 |
| Tm (° C.) 2nd | ASTM D3418-21 |
| heat/DSC | |
| ΔH (J/g) | ASTM D3418-21 |
| Tc (° C.) | ASTM D3418-21 |
| Modulus | ASTM D412 |
| CoF | ASTM D1894 |
| Flame retardancy | ISO 5660, ISO 5660 using a cone calorimeter. Samples of 5 mm |
| | thickness was used and tested in a flame of 35 kW/m2. |

Actual components and physical properties of Part A and Part B are listed in Tables 5 to 8. As mentioned hereinabove, PART A and PART B form 100 (wt. %) of the TPU. Where Part B includes lignin of 30 wt. % of the TPU, the PART A constitutes 70 wt. % of the TPU.

Table 5 and 6 provide for composition of Examples E1 to E19 as well as the physical properties of the TPU so formed.

Table 7 and 8 provide for composition of Examples E20 to E40 as well as the physical properties of the TPU so formed.

Characteristic features of the TPU were tested by METHODS A to D and Standard methods as listed in Table 4. The TPU was found to be associated with improved physical properties as listed in below Tables 5 to 8. Units of measurements are provided in the header of the Tables. (Cold Flex value is at 50 k cycle).

TABLE 5
EXAMPLES E1 TO E19

| | PART | Part B | Shore | Density | Density | Abrasion | Gloss | Gloss | | | |
|---|---|---|---|---|---|---|---|---|---|---|---|
| Ex. | A | wt./% | A | (Pellets) | (Plaques) | Loss (mm3) | (20°) | (60°) | MFI | TS (MPa) | St (%) |
| E1 | A1 | 0 | 55 | 1.06 | 1.08 | 46.22 | 33 | 8.5 | 642 (180) | — | — |
| E2 | A1 | 30 | 70 | 1.02 | 1.15 | 31.45 | 4.3 | 27.3 | 643 (190) | 15.85945 | 450.26 |
| E3 | A1 | 50 | — | 1.01 | 1.19 | 29.10 | 1.8 | 16.1 | 624 (190) | — | — |
| E4 | A2 | 0 | 63 | 1.04 | 1.08 | 25.74 | 54 | 104 | 233 (190) | — | — |
| E5 | A2 | 30 | 75 | 1.17 | 1.14 | 109.33 | 3.4 | 29 | 241 (190) | 11.46 | 603.57 |
| E6 | A2 | 50 | 85 | 0.84 | 1.19 | 152.43 | 1.5 | 21 | 400 (190) | — | — |
| E7 | A3 | 0 | 72 | 1.04 | 1.08 | 48.00 | 71.8 | 111 | 54 (190) | 30.77 | 836.79 |
| E8 | A3 | 30 | 80 | 0.89 | 1.15 | 33.03 | 2.4 | 19.7 | 32.5 (190), 377 (210) | 10.84 | 230.66 |
| E9 | A3 | 50 | 92 | 0.80 | 1.18 | 70.69 | 2.2 | 28.1 | 23.9 (190), 221 (210) | — | — |
| E10 | A4 | 0 | 84 | 1.04 | 1.20 | 35.00 | 82.4 | 116 | 50 (190) | — | — |
| E11 | A4 | 2.5 | 83 | — | — | — | 55 | 78 | 50 (190) | — | — |
| E12 | A4 | 5 | 84 | 1.12 | 1.12 | 14.95 | 75 | 87 | 79 (190) | — | — |
| E13 | A4 | 10 | 85 | 1.09 | 1.13 | 23.36 | 43 | 72 | 16 (190) | — | — |
| E14 | A4 | 20 | 88 | 1.13 | 1.15 | 66.49 | 15.6 | 50 | 52 (210) | 20.6 | 625.2 |
| E15 | A4 | 30 | 92 | 0.93 | 1.16 | 89.40 | 3.3 | 26 | 231 (190) | 17.3 | 575.9 |
| E16 | A4 | 50 | 93 | 0.74 | 1.21 | 86.17 | 0.4 | 6.4 | 275 (190) | 15.9 | 257.0 |
| E17 | A5 | 0 | 91 | 1.05 | 1.13 | 28.00 | 138 | 147 | 31.5 (190) | 43.52 | 550.55 |
| E18 | A5 | 30 | 95 | 1.08 | 1.18 | 41.36 | 2.4 | 19 | 152 (190), 221 (210) | 18.3 | 269.4 |
| E19 | A5 | 50 | 97 | 0.76 | 1.22 | 92.17 | 6.2 | 29.3 | 414 (190), 456 (210) | 18.08 | 35.06 |

TABLE 6
EXAMPLES E1 TO E19 CONTINUED

| | Tg (On set, | Tg (I, | Tg (Off set, | Tm (° C.) 2nd | ΔH | Tc | Cold Flex | | | Mode | Mode | Mode | Mode |
|---|---|---|---|---|---|---|---|---|---|---|---|---|---|
| Ex. | ° C.) DSC | ° C.) DSC | ° C.) DSC | heat/DSC | (J/g) | (° C.) | Failure | Modulus | CoF | A | B | C | D |
| E1 | −64.44 | −59.3 | −48.72 | 124.89 | 1.873 | 78.88 | — | — | — | — | — | — | — |
| E2 | −57.54 | −51.84 | −43.08 | 124.98 | 3.605 | 78.92 | — | — | — | — | — | — | — |
| E3 | −54.5 | −44.64 | −33.3 | 125.28 | 2.759 | 78.87 | — | — | — | — | — | — | — |
| E4 | −69.15 | −68.12 | −57.86 | 126.54 | 5.43 | 67.88 | No | 7 | 2.105 | NS | NS | NS | Squeak |
| E5 | −63.48 | −58.44 | −48.24 | 128.4 | 3.85 | N/A | No | — | — | — | — | — | — |
| E6 | −60.18 | −54.01 | −44.41 | N/A | N/A | N/A | No | — | — | — | — | — | — |
| E7 | −63.09 | −57.99 | −47.99 | 126.42 | 8.157 | 77.99 | No | — | — | — | — | — | — |
| E8 | −55.86 | −45.13 | −34.81 | 125.62 | 3.89 | 78.99 | No | — | — | — | — | — | — |
| E9 | −43.97 | −28.03 | −22.5 | 126.03 | 5.6 | 78.05 | No | — | — | — | — | — | — |
| E10 | −45.5 | −35.02 | −26.83 | 150.12 | 9.759 | 55.39 | No | — | — | — | — | — | — |
| E11 | — | — | — | — | — | — | No | — | — | — | — | — | — |
| E12 | — | — | — | — | — | — | No | 12 | 1.069 | NS | NS | NS | Squeak |
| E13 | — | — | — | — | — | — | No | 13 | 0.812 | NS | NS | NS | Squeak |
| E14 | — | — | — | — | — | — | No | 16 | 1.379 | NS | NS | NS | Squeak |
| E15 | −39.05 | −23.92 | −15.03 | N/A | N/A | N/A | No | 17 | 0.988 | NS | NS | NS | NS |
| E16 | −35.08 | −26.08 | −9.27 | 126.91 | 1.639 | 79.14 | No | 45 | 0.841 | NS | NS | NS | NS |
| E17 | −50.4 | −45.32 | −33.12 | 164.05 | 20.55 | 97.22 | No | — | — | — | — | — | — |
| E18 | −48.86 | −35.92 | −23.46 | 155.37 | 10.12 | 79.44 | No | — | — | — | — | — | — |
| E19 | −33.55 | −15.45 | 1.55 | 140.39 | 8.212 | 52.06 | YES | — | — | — | — | — | — |

TABLE 7
EXAMPLES E20 TO E40

| | PART | Part B | Shore | Density | Density | Abrasion | Gloss | Gloss | | TS | |
|---|---|---|---|---|---|---|---|---|---|---|---|
| Ex. | A | (wt. %) | A | (Pellets) | (Plaques) | Loss (mm3) | (20°) | (60°) | MFI | (MPa) | St (%) |
| E20 | A6 | 0 | 48 | 1.19 | 1.18 | 19.79 | 69 | 99 | 405 (190) | — | — |
| E21 | A6 | 30 | 55 | 1.21 | 1.22 | 24.99 | 3.3 | 22 | 643 (190) | 5.99 | 628 |
| E22 | A6 | 50 | 75 | 1.27 | 1.27 | 30.07 | 6 | 15 | 398 (170) | 3.78 | 283 |
| E23 | A7 | 0 | 50 | 1.19 | 1.19 | 8.47 | 33 | 84 | 389 (190) | — | — |
| E24 | A7 | 30 | 65 | 1.20 | 1.22 | 28.13 | 1 | 10 | 375 (170) | 5.67 | 572 |
| E25 | A7 | 50 | 80 | 1.26 | 1.26 | 39.12 | 1.8 | 17.3 | 591 (170) | — | — |
| E26 | A8 | 0 | 85 | — | 1.19 | 30.76 | 107 | 120 | 30.6 (190), 98 (210) | — | — |
| E27 | A8 | 30 | 90 | — | 1.23 | 89.96 | 22 | 64.8 | 46 (190) | 17.85 | 440.15 |
| E28 | A8 | 50 | 95 | — | 1.27 | 136.17 | 1.4 | 13.5 | 108 (190) | 17.11 | 147.8 |
| E29 | A9 | 0 | 85 | — | 1.18 | 18.64 | 6.1 | 102 | 14 (190) | | |
| E30 | A9 | 30 | 91 | — | 1.22 | 111.56 | 3.7 | 27.9 | 38 (190) | 17 | 442.83 |
| E31 | A9 | 50 | 95 | — | 1.24 | 112.08 | 1.6 | 7.7 | 28.5 (190) | 18.19 | 116.6 |
| E32 | A10 | 0 | 87 | — | 1.20 | 35.66 | 9.4 | 137 | 29.5 (190) | | |
| E33 | A10 | 30 | 93 | — | 1.24 | 123.54 | 3.4 | 23.6 | 73 (190) | 13.64 | 332.77 |
| E34 | A10 | 50 | 96 | — | 1.27 | 110.82 | 1.2 | 10.8 | 111 (190) | 17.097 | 32.56 |
| E35 | A11 | 0 | 86 | — | 1.16 | 20.93 | 145 | 144 | — | — | — |
| E36 | A11 | 5 | 88 | — | 1.18 | 102.00 | 72.6 | 88.2 | 5 (190) | — | — |
| E37 | A11 | 10 | 90 | — | 1.19 | 106.00 | 63.7 | 85.8 | 5.6 (190) | — | — |
| E38 | A11 | 20 | 92 | — | 1.20 | 106.94 | 39.2 | 77.3 | 6 (190) | 20.15 | 480.9 |
| E39 | A11 | 30 | 95 | — | 1.22 | 108.00 | 14.7 | 47.9 | 20.5 (190) | 15.34 | 315.78 |
| E40 | A11 | 50 | 97 | — | 1.24 | 109.12 | 1.3 | 12.5 | 24 (190) | 18.52 | 56.18 |

TABLE 8
EXAMPLES E20 TO E25 CONTINUED

| | | | | | | | Cold | | | | | | |
|---|---|---|---|---|---|---|---|---|---|---|---|---|---|
| | | | | | | | Flex | | | | | | |
| | Tg (On | Tg (I, | Tg (Off | Tm (° C.) | | | Failure | | | | | | |
| | set, ° C.) | ° C.) | set, ° C.) | 2nc | ΔH | | (@ 50k | | | | | | |
| Ex | DSC | DSC | DSC | heat/DSC | (J/g) | Tc (° C.) | cycle) | Modulus | CoF | Mode A | Mode B | Mode C | Mode D |
| E20 | — | — | — | — | — | — | — | 3 | 2.23 | NS | NS | NS | Squeak |
| E21 | — | — | — | — | — | — | — | 4 | 1.71 | NS | NS | NS | NS |
| E22 | — | — | — | — | — | — | — | 7 | 1.53 | NS | NS | NS | NS |
| E23 | — | — | — | — | — | — | — | 5 | 3.13 | NS | NS | NS | NS |
| E24 | — | — | — | — | — | — | — | 6 | 1.22 | NS | NS | NS | NS |
| E25 | — | — | — | — | — | — | — | 12 | 1.63 | NS | NS | NS | NS |

*NS = No squeak

Tables 5 to 9 denote the improved physical properties of the TPU as claimed.

Examples E1, E4, E7, E10, E17, E20, E23, E26, E29, E32, E35 are control examples (with 0 wt. % of Part B, i.e. lignin).

Shore A hardness increased with lignin content, i.e. Part B, see Shore A value increase across Examples with increasing lignin content in Part B.

Abrasion loss data across E5, E6, E9, E15, E16, E19, E27, E28, E30, E31, E33, E34, E39 and E40 when compared to the control Examples and other examples indicate that the abrasion loss increases with increasing lignin content. However, by varying Part A matrices and keeping Part B value within 20 to 50 wt. % of the reaction mixture of TPU, the abrasion loss is significantly controlled.

Wet slip resistance was determined by the method A as mentioned above. At higher load (i.e. 19 and 104 N), inclusion of lignin increased the dynamic coefficient of friction of TPU which indicated better wet slip resistance in Lignin/TPU composites than in control TPU (with 0 wt. % of Part B, i.e. lignin).

Squeaking was determined by the method B as mentioned above. No squeaking was observed in Examples where the reaction mixture of TPU had about 30 and 50 wt. % of Part B with lignin.

Young's modulus increased with increased Part B value (i.e. lignin content) while maintaining high deformability (˜200% for 50 wt. % lignin) even at high lignin content.

Gloss was measured at 20 and 60° showing that as the lignin content (Part B) is increased, the gloss value decreased at both 20 and 60°. The gloss value at 20 and 60 degree decreases significantly with increasing lignin content. 50 wt. % lignin containing samples showed lowest gloss values. Accordingly, the disclosed TPU composition is suitable where minimum diffuse reflection of the surface is needed. Gloss value indicates that the lignin in Part B enhances the surface properties of the TPU by acting as a matting agent.

Viscosity data of Examples E10, E13, E15, E16, E7. E9, E4 and E6 are provided below in Table 9. Shear rate (1/s) is provided in the first column on the left. Viscosity (Pa·s) at 200° C. was calculated by Method C. Increasing Part B value (i.e. lignin content) did not increase the viscosity significantly while improving the melt-strength of the Examples.

Melt flow value for Examples with Part B value in range of 30 to 50 wt. % of the reaction mixture of the TPU is significantly improved.

Atomic force microscopy (AFM) morphology results of the Examples 11 to 15 (See FIG. 1) denote lignin particles are well dispersed in the matrix. The average particle size d 50 of the lignin particles is 1-2 microns. The AFM images in FIG. 1 show good dispersion of lignins in TPU matrix. The bright phases are lignin in the images. The higher magnification images show good adhesion between lignin and TPU matrix. Lignin shows viscoelastic behaviour at melt and thus lignin particles get disintegrated to smaller particles during melt extrusion. In order to understand the effect of dispersion on the surface modulus of lignin containing TPU, AFM was used to scan the modulus across the injection molded TPU/Lignin samples. It was observed that the surface modulus was three times higher than the bulk modulus. FIG. 2 shows the AFM images with surface modulus map.

TABLE 9
Shear Rate value

| Shear | | | | | | | | |
|---|---|---|---|---|---|---|---|---|
| Rate | E10 | E13 | E15 | E16 | E7 | E9 | E4 | E6 |
| 50 | 1889.21 | 1159.93 | 1174.74 | 1027.91 | 1295.53 | 913.64 | 368.29 | 458.88 |
| 100 | 1555.86 | 1028.99 | 1003.66 | 856.70 | 1079.96 | 735.71 | 327.54 | 391.71 |
| 200 | 1178.12 | 890.11 | 860.55 | 740.62 | 851.67 | 641.90 | 292.17 | 342.36 |
| 500 | 732.08 | 546.60 | 538.71 | 446.54 | 548.06 | 404.69 | 212.218 | 230.09 |
| 500 | 718.20 | 637.89 | 628.64 | 562.74 | 560.18 | 496.68 | 229.16 | 275.17 |
| 1000 | 489.01 | 395.69 | 386.37 | 328.08 | 380.32 | 301.43 | 162.39 | 178.1 |
| 2000 | 300.88 | 258.43 | 254.43 | 221.06 | 243.76 | 211.54 | 115.24 | 130.57 |
| 5000 | 162.13 | 131.3 | 132.02 | 121.61 | 123.55 | 116.89 | 65.88 | 78.94 |
| 10000 | 96.77 | 77.75 | 75.39 | 71.54 | 79.29 | 68.82 | 40.9 | 49.74 |

Examples E10, E15 and E16 were tested for ability of the TPU for flame retardancy. The Examples were tested for Total heat release (THR) kW/m²; Peak of heat release (PHRR) kW/m² and Ability to self-extinguish. Examples E15 and E16 with lignin in Part B show improved flame retardancy properties based on the values of the THR, PHRR and ability to self-extinguish. The TPU compositions of Examples E10, E15 and E16 were further modified to check the effect of lignin on flame retardancy in presence of additional plasticizer (Plast) and in presence of additional flame retardant (FHF) respectively. Even with the variation having additional plasticizer and flame retardant, the TPU composition shows improved flame retardancy that can directly be attributed to the presence of lignin in the Part B of the TPU composition. See Table 10 below.

TABLE 10
FLAME RETARDANCY

| | (THR) | (PHRR) | Self-extinguishing |
|---|---|---|---|
| Example | MJ/m² | MJ/m² | ability |
| E10 | 150 | 1803 | 26 |
| E15 | 149 | 490 | 21 |
| E16 | 136 | 428 | 18 |
| E10 with A4 having additional plasticizer | 129 | 1365 | 123 |
| E15 with A4 having additional plasticizer | 120 | 350 | 132 |
| E16 with A4 having additional plasticizer | 100 | 419 | 97 |
| E10 with A4 having additional flame retardant | 145 | 462 | 45 |
| E15 with A4 having additional flame retardant | 129 | 291 | 48 |
| E16 with A4 having additional flame retardant | 118 | 324 | 24 |

1. A thermoplastic polyurethane (TPU) composition prepared from a reaction mixture, comprising:
a. Part A, comprising
i. at least one isocyanate reactive component; and
ii. at least one isocyanate in a range of 15 wt. % to 45 wt. % of Part A; and
b. Part B, comprising at least one lignin component;
wherein the at least one isocyanate reactive component comprises at least one polyol, at least one chain extender, and optionally at least one additive,
wherein the at least one additive is in a range of 0.40 wt. % to 25.00 wt. % of Part A and the at least one chain extender is in a range of 1.0 wt. % to 10.0 wt. % of Part A, and
wherein the at least one lignin component is in a range of 10.0 wt. % to 60.0 wt. % of a total weight of the reaction mixture.

2. The TPU composition of claim 1, wherein the at least one polyol has an average functionality in a range of 2.0 to 8.0, a hydroxyl number in a range of 20 mg KOH/g to 800 mg KOH/g, and a nominal molecular weight in a range of 200 g/mole to 6000 g/mole.

3. The TPU composition of claim 1, wherein the at least one polyol is selected from the group consisting of a polyether polyol, a polyester polyol, a polyetherester polyol, a polytetrahydrofuran, a polyester diol, and combinations thereof.

4. (canceled)

5. The TPU composition of claim 1, wherein the at least one lignin component is in a range of 20.0 to 50.0 wt. % of the reaction mixture.

6. The TPU composition of claim 1, wherein the at least one lignin component has an average particle size in a range from 10 to 40 μm analysed by a Malvern Mastersizer® 3000 Particle Size Analyzer in dry powder mode.

7. The TPU composition of claim 1, wherein the at least one lignin component is selected from the group consisting of raw lignin, chemically treated lignin, and combinations thereof.

8. (canceled)

9. The TPU composition of claim 1, wherein the at least one additive is present, and is an antioxidant.

10. The TPU composition of claim 1, wherein the TPU has a shore A hardness is in a range from 70 to 100 determined by ASTMD2240.

11. The TPU composition of claim 1, wherein the TPU has abrasion loss in a range from 1.0 to 150 determined by ASTM D5963.

12. A first method of forming the TPU composition of claim 1, the method comprising:
a. mixing the at least one isocyanate reactive component and the at least one isocyanate of Part A to form a first mixture;
b. adding the at least one lignin component of the Part B to the first mixture to form the reaction mixture; and
C. optionally heating the reaction mixture.

13. A second method of forming the TPU composition of claim 1, the method comprising:
a. providing the at least one lignin component of Part B and the isocyanate reactive component of Part A,
wherein the isocyanate reactive component of Part A comprises at least one polyol and at least one chain extender;
b. mixing the at least one lignin component of Part B and the isocyanate reactive component of Part A to form a premix; and
c. mixing the premix with the at least one isocyanate of Part A to form the TPU composition.

14. The method of claim 13, wherein the premix is formed at a temperature in a range from 40° C. to 250° C.

15. The method of claim 13, wherein the premix is mixed with the at least one isocyanate at a temperature in a range from 50° C. to 100° C.

16. The method of claim 12, wherein the isocyanate reactive component of Part A comprises at least one polyol, at least one chain extender, and optionally at least one additive selected from the group consisting of an antioxidant, a mold release agent, a lubricant, a plasticiser, a hydrolysis stabilizer, an anti-blocking agent, a light stabilizer, a cross linker, a catalyst, a flame retardant, a rheology additive, a defoamer, a friction reducer, an antistatic agent, a surfactant, and other components, and combinations thereof.

17. The method of claim 12, wherein the TPU composition is prepared by a melt compounding process.

18. The method of claim 12, wherein the TPU composition is prepared by a one-shot process.

19. The method of claim 12, wherein the TPU composition is prepared by a belt line production process.

20. (canceled)

21. An article prepared from the TPU composition of claim 1.

22. (canceled)

23. A method, comprising:
preparing a receiving unit, an insole, and er and/or an outsole of a footwear from the TPU composition of claim 1.

24. An article, comprising:
at least one receiving unit configured to receive an appendage of a user;
optionally at least one outsole; and
optionally at least one insole configured to support the appendage and disposed between the at least one receiving unit and the at least one outsole,
wherein the at least one receiving unit, the at least one insole and/or the at least one outsole is formed of the TPU composition as claimed in claim 1.

25-29. (canceled)
